(19) United States
(12) Patent Application Publication
(10) Pub. No.: US 2006/0191426 A1
(43) Pub. Date: Aug. 31, 2006

(54) Bundled printed sheets

(76) Inventors: Lee Timmerman, Madison Lake, MN (US); Doug Flitter, Mankato, MN (US); Lane Gravley, Mankato, MN (US); Corey Klein, Portland, OR (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/327,642

(22) Filed: Jan. 6, 2006

Related U.S. Application Data
(63) Continuation-in-part of application No. 10/860,605, filed on Jun. 3, 2004.
(60) Provisional application No. 60/475,935, filed on Jun. 3, 2003.

(51) Int. Cl. B41F 19/02

(52) U.S. Cl. 101/24

(57) ABSTRACT

Systems and methods for manufacturing bundled printed sheets. The printed sheets can be used for labels, business cards, greeting cards, trading cards, tickets, game cards, bank cards, phone cards, identification cards, note pad sheets, paper currency, negotiable instruments, interlaced images, coupons, chits, ballots, maps, forms, time sheets, and like applications. The system generally comprises a substrate staging area, a print module, a cutter module, a collator module, conveyor module, and a packaging module. The system of the present invention can also comprise optional coating or treatment modules, web inspection equipment, waste removal equipment and other such features, and can be web- or sheet-fed.

### RELATED APPLICATIONS

This application is a continuation-in-part of U.S. patent application Ser. No. 10/860,605, filed on Jun. 3, 2004, and entitled “BUNDLED PRINTED SHEETS,” which claims priority to U.S. Provisional Patent Application Ser. No. 60/475,935, filed Jun. 3, 2003, entitled “CUT-AND-STACK LABEL PRODUCTION SYSTEM AND METHOD,” the disclosures of which are incorporated herein by reference in their entireties.

### BACKGROUND OF THE INVENTION

Printed sheet articles and systems for producing large quantities of printed sheet articles are known. One example of a printed sheet article frequently created in large quantities is a label printed on a paper or plastic sheet or cut from a paper or plastic web substrate. Such labels may be subsequently applied to bottles and containers. In one specific example, paper labels are printed and applied to plastic beverage bottles. The labels are wrapped around a portion of the bottle and may be affixed by an adhesive at overlapping ends of the labels.

Such labels for beverage bottles may be printed and packaged at a first location by a print vendor and shipped to a beverage bottler for application inline with the bottling process. The labels are therefore assembled into batch quantities, secured, and packaged so that the bottler need only remove the label assemblies from the shipping packaging, removing the securing device(s), and loaded into an automated labeling machine. This process, however, is complicated by a variety of factors. First, coatings on the labels must be suitably dry before being assembled, packaged, and shipped so that adjacent labels do not become adhered to one another. Coatings can include inks, adhesives, varnishes, antistatic coatings, and other suitable coatings and combinations thereof. These labels can jam the automatic labeling machine, resulting in downtime and potential machine damage. Second, residual moisture in the labels can result in curling or deformation of the labels, again creating problems for loading and operating an automatic labeling machine. The time required to adequately dry the coatings on the printed labels prior to post-process assembly, securing, and packaging to prevent these and other problems significantly increases the turn-around time of the print vendor and reduces responsiveness to customer needs and requests. Climate-controlled environments with reduced humidity are frequently also needed to prevent curling and warping of the labels prior to packaging and shipping.

Further, the assembly, securing, and packaging of the labels increases the cost of the labels, both for the materials needed by the print vendor to accomplish these tasks but also for the bottler, who must have an employee open the shipping carton, remove a label assembly, unpack the assembly, and finally load the unbound and unpackaged assembly into the labeling machine. These tasks must be carried out without bending or creasing the labels or disturbing the assemblies. The employee frequently must also separate the labels if multiple labels have become stuck together to prevent system downtime.

Therefore, a need exists for improved bundled printed sheet articles and methods of manufacture to reduce production and supply times while improving quality and end-user efficiencies. There also exists a need for an effective apparatus for the manufacture of bundled printed sheet articles according to the aforementioned needs.

### SUMMARY OF THE INVENTION

The present invention substantially addresses the aforementioned needs by providing systems and methods for manufacturing bundled printed sheets. The bundled printed sheets and articles are preferably of a superior quality, including a high print quality, uniform desired length and width dimensional attributes, and high print-to-cut registration attributes. The systems and methods of the present invention allow bundled printed sheets to be printed, converted, and packaged at reduced production and supply times without comprising quality of the end product and/or the end-user's efficiency in subsequent processes.

The system of the present invention generally comprises a substrate staging area, a print module, a cutter module, a collator module, conveyor module, and a packaging module. The system of the present invention can also comprise optional coating or treatment modules, web inspection equipment, waste removal equipment and other such features. The system can comprise a web- or sheet-fed module.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a schematic diagram of a web-based apparatus for making bundled printed sheet articles in accordance with one embodiment of the present invention.

FIG. 2 is a schematic diagram of a sheet-fed based apparatus for making bundled printed sheet articles in accordance with one embodiment of the present invention.

FIG. 3 is a flow diagram of a web-based process for preparing bundle printed sheets in accordance with one embodiment of the present invention.

FIG. 4A is a perspective diagram of a portion of a web-based apparatus for preparing bundle printed sheets in accordance with one embodiment of the present invention.

FIG. 4B is a section view of a cutter module in a web-based apparatus for preparing bundle printed sheets in accordance with one embodiment of the present invention.

FIG. 5 is a flow diagram of a sheet-fed based process for preparing bundled printed sheets in accordance with one embodiment of the present invention.

FIG. 6A is a perspective diagram of a collator module of an apparatus for preparing bundled printed sheets in accordance with one embodiment of the present invention.

FIG. 6B is a perspective diagram of a conveyor module of an apparatus for preparing bundled printed sheets in accordance with one embodiment of the present invention.

FIG. 7A is a perspective diagram of a conveyor module of an apparatus for preparing bundled printed sheets in accordance with one embodiment of the present invention.

FIG. 7B is a perspective diagram of a conveyor module of an apparatus for preparing bundled printed sheets in accordance with one embodiment of the present invention.

FIGS. 8A-8E are diagrammatic examples of cut patterns for forming cut printed sheets in accordance with one embodiment of the present invention.

FIGS. 9A-9D are diagrammatic examples of bundled printed sheets in accordance with one embodiment of the present invention.

### DETAILED DESCRIPTION OF THE DRAWINGS

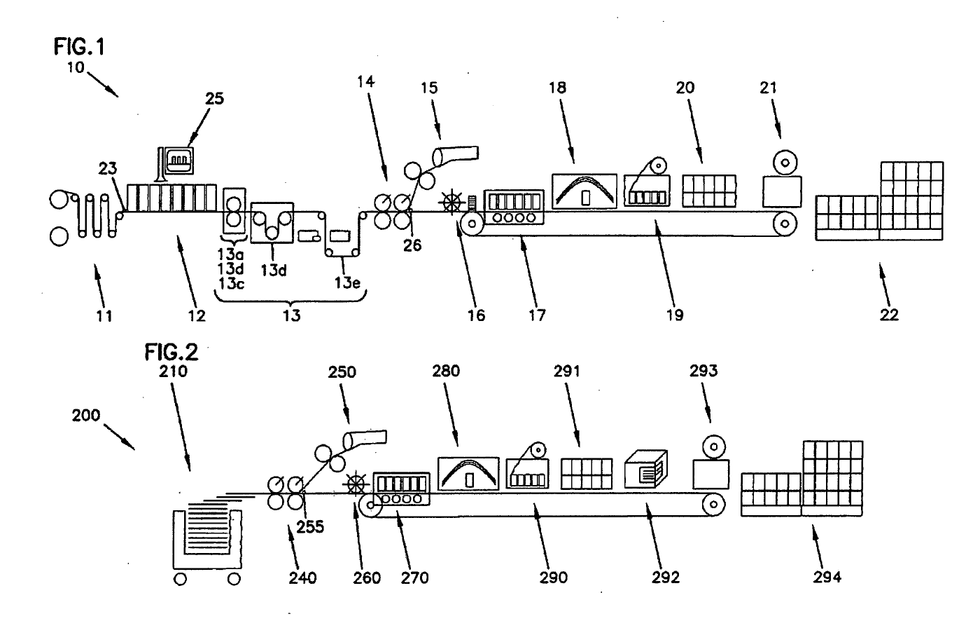

The present invention relates to bundled printed sheets, and apparatuses, systems, and methods for preparing bundled sheets. The invention can be more readily understood by the following description, with reference where applicable to FIGS. 1-9D. While the invention is not necessarily limited to the specifically depicted application(s) described herein, the invention will be better appreciated using a discussion of exemplary embodiments in specific contexts.

In one embodiment, the present invention is directed to bundled printed sheets and bundled printed sheet articles. The bundled printed sheets and articles are preferably of a superior quality, including a high print quality, uniform desired length and width dimensional attributes, and high print-to-cut registration attributes. The present invention also comprises an apparatus for making bundled printed sheets and articles and methods for making and using bundled printed sheet articles.

The present invention provides a stack of printed sheets comprising a plurality of printed sheets in a unitary form, each printed sheet having a narrow cut-to-print registration variance, for example, of from less than or equal to about 0.03 inches, and each printed sheet having the substantially same length and width dimensions as the other printed sheets in the stack to within a narrow variance of less than or equal to about 0.005 inches. The stack of printed sheets is adapted to be situated, for example, in a label applicator machine. The printed sheets of the stack can be product labels having product collateral information, images, text, and like markings, or combinations thereof, printed thereon. The stack of printed sheets can be a unitary form such as a parallelepiped, having, for example, all square corners of about ninety degrees, such as a cube or an elongated cube. A cube has substantially identical length, width, and height dimensions. An elongated cube may have one, two, or three of its length, wide, or height dimensions being different from one another.

The printed sheets can be used for, but are not limited to, for example, labels, business cards, greeting cards, trading cards, tickets, game cards, bank cards, phone cards, identification cards, note pad sheets, paper currency, negotiable instruments, interlaced images, coupons, chits, ballots, maps, forms, time sheets, and like applications, or combinations thereof. The printed sheets can be used in, but are not limited to, a variety of applications including, for example, individual product labels, such as used on beverage containers or canned goods, signage, bumper stickers, and like applications.

The present invention includes an article having a printed sheet attached thereto prepared by a method of affixing printed sheets to articles. The printed sheet being attached to the article can be obtained from unpackaging a bundle of printed sheets of the invention, the bundle comprising a plurality of printed sheets in a stack, optionally having a band around the stack, and an overwrapper on the banded or unbanded stack, and affixing the printed sheet to the article with a label applicator machine, or other means of application or affixation. Methods for manufacturing labels, such as self-adhesive labels, for use in a label applicator machines are known, see for example, U.S. Pat. No. 6,273,987. Label applicator machines and methods for applying labels to articles or containers are known; see for example, U.S. Pat. No. 4,793,891. U.S. Pat. No. 4,798,648 discloses an article-feeding device for use in a label applicator machine, and also discloses forming adhesive labels by die-cutting from a web, intermediate transfer of the cut labels, and application of the labels to articles. High speed label applicator machines for high volume solutions using hot melt adhesives, cold adhesives, pressure sensitive adhesives, or combinations thereof, and conveyor equipment are also commercially available from, for example, Abacus Label Applications, Maple Ridge, B.C. Canada (www.abacuslabel.com).

According to one embodiment of the invention, a bundle comprises a stack of a plurality of printed sheets. A stack is generally a plurality of unsupported cut printed sheets piled atop one another and having substantially the same orientation and may also be a loose but ordered ream of cut printed sheets, and a bundle is generally a stack of cut printed sheets having a securing band, a protective overwrapper, a partial overwrapper, or combinations thereof. The bundles of printed sheets can comprise sheets having, for example, a regular or an irregular shape, such as irregular or non-uniform dimensions, but where all the sheets in the bundle have substantially the same shape and dimensions as all other sheets in the bundle. Each sheet in the bundle preferably has substantially the same orientation in an arbitrary orthogonal x-y-z coordinate system. Each sheet preferably occupies an x-y plane and the sheets are stacked one on top of another about the z-axis in the orthogonal x-y-z coordinate system or Cartesian coordinate system. Each sheet can have substantially the same x- and y-dimensions as all other sheets in the stack, for example, as measured in an x-y plane. In one embodiment, the x- and y-dimensions for each sheet can be the same (x=y), such as a square sheet. In other embodiments, the x- and y-dimensions for each sheet can be different (x≠y), such as a rectangular sheet. The x-dimension for each sheet can also be substantially the same to provide a stack with sheets all having the same variation in the x-dimension, for example, a sheet having an irregular x-dimension. The y-dimension for each sheet can also be substantially the same to provide a stack with sheets all having about the same variation in the y-dimension, for example, a sheet having an irregular y-dimension. The x- and the y-dimensions for each sheet can also vary to provide a stack or bundle having sheets which all have about the same variation in the x- and y-dimensions, for example, a sheet having irregular x- and y-dimensions.

The individual sheets can be of almost any shape and configuration to form bundles of varying shapes and configurations. Various embodiments of the present invention thereby provide bundles of printed sheets in which the individual sheets can have a variety of shapes, for example, square, diamond, heart, rectangular, circular, oval, triangular, and like regular shapes or irregular shapes. In one embodiment, two opposite sides of the stack can be parallel where, for example, the bundle resembles a cube comprised of square sheets, or, for example, where the bundle resembles a parallelepiped or a rectangular block comprising of rectangular sheets. In another embodiment, two opposite sides are not parallel, such as when the bundle is other than a cube or parallelepiped. The bundle can have a unitary or uniform shape but for the irregular shape of the constituent sheets. Thus, because of the high uniformity or similarity of sheet-to-sheet dimensions the resulting bundle formed from irregularly shaped stacked sheets can also have high dimensional uniformity in the x-, y-, and z-directions. Bundles can have at least one set of non-parallel opposite sides, such as where sheets have an irregular shape like a bow-tie-shaped outline in an arbitrary x-y plane, a paisley shape, a tear-drop shape, a lightening bolt shape, and other irregular shapes. Other sheet shapes can include, for example, circles, ovals, squares, and rectangular sheets having square corners, rounded corners, or angled corners. It will be readily apparent that certain sheet shapes can have parallel edges yet still appear irregular, such as a sheet having a saw-tooth or diagonal cut-out pattern on one or more edges. It is also readily evident that sheet edges of the sheets when stacked become part of the sides of the stack or bundle. It will also be apparent that sheets can be made with cut-outs or perforations, for example, for preparing labeled articles with a detachable label portion.

The bundled printed sheets of and created according to the present invention are preferably substantially identical to one another, wherein, for example, the dimensions of each sheet are substantially the same as every other sheet in a bundle, and wherein the dimensions of each bundle are substantially the same as every other bundle. The present invention therefore distinguishes from known document printing, reproduction, or reprographic systems having, for example, printing, collating, finishing, and like capabilities, but where the resulting printed sheets are not precisely cut into two or more smaller identical printed sheets from fed sheets or a continuous web. The present invention may include aspects of known web-based or sheet-fed document printing, reproduction, or reprographic systems, however, without departing from inventive aspects.

The bundled printed sheets can have sheet-to-sheet print or image content which is constant, variable, or both, and can provide substantially identically dimensioned printed sheets and substantially identically dimensioned bundled printed sheets. The bundled printed sheets can then be assembled or fashioned into, for example, multi-page documents, such as bound booklets, manuals, brochures, coupons booklets, check bundles, or like printed publications or collateral materials. See, for example, U.S. Pat. No. 4,368,972. The bundled printed sheets can also be used to supplement or modify multiple page documents, such as with correction labels, advertising labels, bookmarks, promotional inserts, and like applications.

Systems, methods, and processes of the present invention provide overall accelerated production speed and increased volume throughput compared to known production processes for bundled printed sheets. For example, in current high-volume printed label production systems, considerable time passes, such as from about six to about forty-eight hours or more, from the time labels or other sheet products are printed until the time the labels are packaged because of the need for inks or coatings to properly dry or cure. Such time lapses increase the likelihood that moisture will evaporate from or penetrate into a printed sheet and potentially cause print quality or handling issues for individual sheets in use. In one preferred embodiment of the present invention, the total time required between, for example, printed sheet formation and application of packaging materials is greatly decreased to less than about one to four minutes, as shown in TABLE 1.

The bundled printed sheet products of the present invention provide a superior product for print-to-cut quality and stack uniformity properties, produced in less time, and at a lower relative cost, compared to other available apparatus and methods. The bundled printed sheet products of the present disclosure, with or without additional packaging, are also suitable for immediate use by a customer or user, for example, a packaging or labeling vendor-customer engaged in a high speed label application operations. Such a product is more responsive to current and future customer needs, for example, for print-on-demand availability or just-in-time inventory and their concomitant advantages. The bundled printed sheet products of the present disclosure can provide a vendor-customer with bundled sheet products of high quality and in high volumes and having less overall waste, including reduced packaging waste packaging and fewer waste or unusable printed sheets. Waste sheets historically had to be manually detected and discarded and often caused costly disruptions or unnecessary down-time in customer operations.

The bundled printed sheets of the present invention, including banded and overwrapped bundles of labels, further provide benefits to processes of applying, attaching, or otherwise affixing a printed label to an article, such as a consumer product container or package. In previous label manufacturing methods, the printed labels often needed to be supported with chipboard, or other similar cumbersome materials, and shrink-wrapped to unify the stack. To use those bundled labels in a labeling machine, the shrink-wrap had to be manually cut off, the chipboard support removed, and the label stack placed in a label applicator machine to be fed onto the receiver package. This method of placing labels in a label applicator machine is prone to misaligned labels, which can in turn cause label misfeeds or jams and can result in inferior label application, waste, or rework, and compromised label application productivity.

The present invention provides solutions to these and other problems. In one embodiment, stacks are bundled with a band, an overwrapper, or a combination thereof for ease of handling and use in post-production manufacturing. A band generally surrounds at least a portion of a registered stack. The ends of a band around the stack can preferably overlap each other and the overlap portion can preferably include a point of attachment. The point of attachment can be accomplished, for example, with an adhesive, a weld, a crimp, Velcro®, and other fastening or joining techniques or combinations thereof. The band can be any suitable binding material, such as plastic, paper, metal, rubber, elastomer, string, and like materials or combinations thereof. The bundle of printed sheets can have, for example, from one to five bands or more. In embodiments in which the bundle of sheets is long and rectangular, the bundle can have two or more bands, such as two to three bands. In an embodiment in which the bundle and its stacked sheets are relatively stable against skewing without a band or where cost or use considerations suggest, a single band around the bundle can suffice to maintain a useful and unitary shape of the bundle.

The overwrapper can be, for example, any suitable wrapper material or shrink-wrap material, such as clear, translucent, or opaque materials including but not limited to natural or synthetics, such as plastic, paper, and other materials or combinations thereof. The overwrapper on the banded stack can include one or more pull-tabs or tear-strips to facilitate removal of the overwrapper from the bundle. In one embodiment, the overwrapper on the banded stack completely encloses the bundle. In other embodiments, the overwrapper on the banded stack incompletely encloses the bundle, having open-end regions or open-side regions, or where the overwrapper does not cover all or a substantial portion of the stack covered by a band. Bundles of printed sheets according to the present invention can also be prepared, if desired, with a band but without an overwrapper and still retain their unitary shape and cut-to-print registration variance, with individual sheets having the same length and width dimensional variance as the other printed sheets in the stack or bundle.

Although not required as previously mentioned, the bundles can include, if desired, a chipboard, a stiffener panel, or combinations thereof. See, for example, U.S. Pat. No. 4,830,186, assigned to Xerox Corp., to provide a removal support structure to stabilize the stack or bundle from inadvertently skewing or toppling during handling or use. For reasons mentioned above, the bundled printed sheets of the present invention are preferably free of a chipboard, a stiffener panel, or like articles.

In one embodiment, the combination of banding and overwrapping the stacks simplifies loading printed sheet labels into a label applicator machine. In one embodiment, a banded stack comprises a band placed or applied around the stack and encompassing a portion of two opposite sides including the full height of the stack, and a portion of the outer facing top and bottom sheets of the stack including the full width of the stack. An equipment operator, robot, or automated loading device can then simply unwrap the stack with a highly visible tear-strip or tear-tape similar to that used on clear compact disc and media packaging. While the stack is still supported by a band, the label bundle can optionally be fanned out to prevent the labels from cohering and then loaded in the label applicator machine. Then, the band can be slit and removed, for example by a band cutter, leaving the resulting label stack in position and alignment for feeding through the label machine.

In another embodiment of the present invention, an unbanded stack comprises an overwrap. An equipment operator, robot, or automated loading device can then simply unwrap the stack, such as with a highly visible tear-strip or tear-tape similar to that used on clear compact disc and media packaging in one embodiment, and load the stack into the label applicator machine.

The printed sheets of the present invention each have high uniformity, such as low variance in cut-to-print registration and low variance of the length and width dimensions in preferred embodiments. Cut-to-print registration, cut-edges to print registration, print registration to cut edges, print-to-cut registration, and other like phases generally refer to the position of a printed image, in particular an exact, ideal, or desired cut-out pattern of the printed image compared to the actual or achieved cut-out pattern of the printed image in web-fed or sheet-fed embodiments of the present invention. Print-to-print registration generally refers to the position of a printed image with respect to adjacent printed images on a moving web. In one embodiment, the cut-to-print registration variance can be from less than or equal to about thirty thousandths of an inch, for example less than or equal to about 1/32 or an inch, and each printed sheet can have the same length and width dimensions as the other printed sheets in the stack to within a variance of less than about five thousandths of an inch. In one embodiment, the cut-to-print registration variance can be from about 0.03 to about 0.015 inches, or about thirty thousandths of an inch to about fifteen thousandths of an inch, for example from about 1/32 of an inch to about 1/64 of an inch. Each printed sheet can have the same length and width dimensions as the other printed sheets in the stack to within a variance of, for example, from about 0.001 to about 0.005 inches, or from about one thousandth of an inch to about five thousandths of an inch in one embodiment.

Consequently, when the substantially identical sheets are stacked, such as prior or subsequent to bundling by banding, overwrapping, or both, highly uniform stacks and ultimately uniform bundles of printed sheets result. Highly uniform stacks or bundles of printed sheets of the present invention are provided by, for example, the method of making and the apparatus for making as disclosed herein. In one embodiment, high print-to-cut uniformity and high dimensional uniformity of the printed sheets can be attributed at least in part to precision printing methods and precision cutting methods of the present invention. The high uniformity of a stack, that is a group or ream of stacked sheets, results at least in part from the combination of the accurately dimensioned sheets (i.e., low sheet-to-sheet dimensional variation) and the apparatus and methods used for stacking the sheets and the apparatus and methods used to package the sheets into bundles. The abovementioned high uniformity of a stack provides a highly uniform bundle of printed sheets after the uniform stacks are packaged by banding, overwrapping, boxing, or combinations thereof.

The apparatus and methods of the present invention used to make and package the sheets and their resultant bundles, also provide an apparatus and method for making large numbers of bundled printed sheets with high bundle-to-bundle uniformity. Bundle-to-bundle uniformity generally refers to such aspects as appearance uniformity, dimensional uniformity, performance or use uniformity, and like uniformity aspects, between or among bundles produced in the same print job. Additionally or alternatively, high bundle-to-bundle uniformity refers to low bundle-to-bundle variability. Thus, as an example of high bundle-to-bundle uniformity, the first bundles manufactured in a print job, such as bundles one through ten, are substantially identical in all aspects to bundles manufactured in the middle, such as bundles 18,490 to 18,500, or the end, such as bundles 36,990 to 37,000, of a continuous twenty-four-hour print job.

In one embodiment of the present invention, the apparatus and methods can manufacture, for example, from about one to about 150 stacks or bundles of printed sheets per minute. The actual number of bundles made, or the production rate, can depend upon many different variables, including sheet feed or web speed, sheet size or web width, printed piece cut dimensions, the number of pieces cut per web width, conveyor number and speed, banding and wrapping efficiencies, and like considerations. The production rate in this or similar linear productions systems of the present invention is typically rate limited by the slowest step or operation. The present invention can be adapted to reduce the limitations of a linear or assembly line by splitting or dividing stack streams to permit parallel or concurrent processing and increased through-put productivity.

In one embodiment, individual bundles can contain any number of printed sheets. It will be evident to one of ordinary skill in the art that for practical reasons bundles prepared during the same job will preferably have approximately the same number of sheets in each bundle, as is common in the industry. In one embodiment, each stack or bundle of printed sheets can contain, for example, from about ten to about 10,000 printed sheets, preferably from about ten to about 5,000 printed sheets, and more preferably from about fifty to about 1,500 printed sheets. Other sheets-per-bundle counts can be readily prepared if desired, according to economic, operational, handling, customer requirements, and like considerations. It will be readily appreciated that the number of bundles of printed sheets produced per minute can be increased by concurrently operating additional production lines under approximately the same conditions and parameters.

The dimensions of a stack and a resulting packaged bundle can depend upon, for example, the thickness (height or z-dimension) of the web or sheet-fed stock selected; the thickness added to the web or sheet-fed stock as a result of printing, coating, conditioning, or like additions or treatments; the area size (x-y dimensions) of printed sheets cut from the web stock or sheet-fed stock; and the contribution of the packaging materials to the overall bundle dimensions. In one embodiment, the bundle of printed sheets can be of any suitable or desired dimensions to provide bundles that are particularly useful to a user, consumer, or processor of bundled printed sheets, such as a person, machine, or robot that handles the bundles or the constituent individual printed sheets within a bundle. One example of such a machine or robot is a label applicator which may or may not be integrated with other processing or handling equipment. For a label applicator machine having an operator, bundles preferably have dimensions which make handling of the bundles by the operator convenient, such as readily held in a typical human hand, and unwrapped, unbanded, or both, with the other hand. Thus, in one embodiment, a finished bundle of printed sheets can be, for example, about one to about two inches wide, about two to about four inches high, and about three to about ten inches long. The foregoing dimensions may be preferred in example embodiments by operators or handlers and in view of human factor considerations. Other bundle dimensions can be readily selected and achieved in other embodiments of the invention. The high dimensional uniformity of each sheet in the bundle, the high dimensional uniformity of each bundle itself, and the high bundle-to-bundle dimensional uniformity provides bundles and printed sheets that are readily loaded and dispensed from a label applicator machine with high reliability and minimal or no stack or label jamming or stack or label rejection from the label machine.

The bundled printed sheet product or the printed sheets within the bundles of the present invention can have a number of other desirable aspects or advantages depending upon the details of their manufacture and the details of their use or application as mentioned below. In one aspect, the printed sheets can have superior gloss properties when the printed web or sheets are coated with a gloss layer or varnish overcoat during manufacture. Generally, the gloss coated or varnish coated printed sheets can have a reduced glue use or reduced glue requirement by a label applicator machine in applying the printed sheets, such as a label, to an article, such as a bottle, can, and the like, where the ends of the coated printed sheet may be overlapped and attached to each other with an adhesive. Alternatively, an adhesive can be applied to all or a portion of one side of the printed sheet to contact and affix the printed sheet to an article.

The printed sheets in the bundles can be used immediately or very soon after their manufacture, for example within seconds or minutes. Use after manufacture can be accelerated further if the web or sheets are printed and cured with ultra-violet (UV), heat, or other curable ink(s) and/or with a UV or other curable overcoating, such as an ultraviolet curable varnish formulation, and thereafter cured with a suitable UV or other source to provide printed or coated printed sheets. UV curable over-coatings, inline or web coating devices, and UV light sources for curing are commercially available. Thus, printed sheets and subsequently formed bundles of printed sheets of preferred embodiments of the present invention can be made and used on-demand and do not require extended or lengthy time delays associated with an intermediate drying step and which drying step may additionally require special environmental conditions, such as temperature or humidity control, or handling precaution, intermediate storage or warehousing, and like considerations. Uncoated printed sheets or sheets coated with water or aqueous based UV varnishes or coatings typically tend to be more porous compared to organic based UV varnishes or coatings and tend therefore more absorbent of glue formulations, and consequently may have a greater glue requirement and total glue cost, such as by about two-fold, to achieve satisfactory fixing of the printed sheets to articles.

In accordance with the aforementioned features and advantages of the present invention, the bundles, the printed sheets within bundles, or the printed sheets when used, have lower rejection rates and higher acceptance rates among users, such as downstream manufacturers, customers, or consumers, compared to printed sheets made by known processes. In still yet another aspect, the printed sheets within the bundles and the bundles themselves can be used without or with minimal fanning by a user or operator prior to use. Fanning refers to the practice of, for example, quickly parsing the sheets in the stack to separate or aerate adjacent sheets in a stack, preventing cohesion of two or more adjacent sheets.

Referring now to the figures, FIG. 1 depicts an apparatus 10 for making bundled printed sheet articles according to one embodiment of the invention. Apparatus, or production system, 10 is preferably an automated continuous web-based system for high volume production of individual printed sheets from a web, free standing or supported stacks of the printed sheets, and packaged stacks of the printed sheets. “Continuous” in this context generally refers to non-stop operation during a job, or without interruption, for example, for a period of from about ten minutes to about 1,000 hours or more. The method and apparatus of the invention are capable of operating non-stop or without interruption for extended periods of time, such as all day and night for up to a month and beyond, when, for example, web- or sheet-fed stock, inks, coatings, surface treatment material or agents, banding materials, wrapping materials, and like consumables can be replenished as needed to sustain the continuous operation and production of printed sheets and the resulting bundles.

In web-fed embodiments, the web can be printed or imaged to form a plurality of substantially identical printed regions on the web. The printed web can subsequently be precision cut into individual printed sheets. The individual printed sheets can be stacked, the stacks bundled, and the bundles boxed for shipping or storage. The foregoing illustrative steps can be accomplished continuously and without interruption. Other steps, such as a finish coating, anti-static treatment, laminating, and like steps, can optionally be incorporated into embodiments of the apparatus and process of the present invention. A continuous web or sheet stream is generally preferred for productivity and economy. However, occasionally the bundled printed sheet production process of the disclosure may need to be briefly suspended to make, for example, change-overs, adjustments, repairs, and like maintenance or production optimization. The process and apparatus of the present disclosure can be adapted with, for example, controls and quality specifications to permit as-needed temporary suspension or interruption of production without jeopardizing an entire print job. In this sense a sheet stream can have a semi-continuous character when, for example, its flow is temporarily interrupted. The apparatus and process of the present invention thereby provide for continuous high volume and high quality manufacture of bundled printed sheets.

FIG. 1 shows various individually numbered modules only by way of example and to illustrate various preferred embodiments. The modules, or stations, are generally components or subassemblies of an apparatus or system that can accomplish a defined function or operation, such as a print module for printing, a coater module for coating, a cutter module for cutting, a collator module for collating, a conveyor module for conveying, and a packaging module for packaging. The modules described herein with reference, where applicable, to the figures can be adapted to be serially (i.e., modules linked in series) or multiply (e.g., one or more coating modules) integrated with other modules. The modules preferably can be readily modified or serviced in place, or, additionally or alternatively, preferably readily replaced or interchanged with a similar or different module (e.g., a web-based four-color print module interchanged with a sheet-fed xerographic color print module). Individual modules, stations, or components are described in more detail below.

Substrate Staging (Web- or Sheet-Fed)

A substrate is generally a web- or sheet-fed material from which cut printed sheets are prepared. The substrate can be comprised of, for example, paper, film, synthetic materials, foils, metalized version thereof, and like materials, or combinations thereof. A preferred substrate material for economy and versatility is, for example, rolled paper or rolled plastic film. In one embodiment of the present invention, the substrate is pre-coated with adhesive on at least a portion of one face of the web or sheet. Suitable adhesives include, but are not limited to R41309A available from Capital Adhesives, P0518-4-B available from H. B. Fuller, and AS15440A available from ASI. In another embodiment of the present invention, the substrate is pre-laminated with an adhesive and a liner, such as a silicon liner, on at least one face of the web or sheet. In other embodiments, the substrate is uncoated or unlaminated. Substrate feed module or station 11 preferably can be a web-stock loading area where, for example, unprinted paper, plastic film, or other suitable sheet stock is fed into the system using supply rolls and unroll festoons to control tension and other relevant parameters, and to permit adding additional web rolls so as to enable continuous operation over extended periods and without interruption or shut-down. Such web loading and change-over equipment is commercially available from, for example, Keene Technology, Inc., Beloit, Ill.; and Martin Automatic, Inc., Rockford, Ill. A preferred component for this station is the model ZG 2650-10 shaftless butt splicer from Keene Technology, Inc.

Substrate Marking and Inspection

Printing module or station 12 can be, for example, a web offset print engine or like printing equipment that images or prints desired patterns or marks on one or both sides of the web. A print engine generally is any print system or marking technology that is compatible with image or print formation aspects of the present invention. A print engine according to or compatible with the present invention may be but is not limited to digital print technologies, for example.

In various embodiments, printing on the web or on fed sheets (refer also to FIG. 2 and the related discussion below) can comprise any suitable print method, including, for example, offset, lithography, flexography, gravure, non-impact printing methods, electrophotography, and other print methodologies or combinations thereof. Offset printing typically includes an intermediate image receiver, such as a printing plate. Lithography typically includes a printing member having ink receptive regions and ink rejecting regions, which opposite regions result in image and non-image regions on the printing member. Gravure printing methods typically include a printing member having a metal cylinder etched with numerous tiny wells that hold and release ink. Non-impact printing methods can use, for example, lasers as in laserography, ions as in ionography, ink jet as in thermal ink jet or bubble ink jet, thermal transfer imaging, and like methods and devices to form or transfer images on or to a receiver, such as a continuous web or a single sheet receiver. Electrophotographic printing methods include, but are not limited to, for example, xerography (e.g., from Xerox Corp), liquid immersion development (LID, e.g., from Indigo), ionography (e.g., from Delphax), and other like methods. In various embodiments of the present invention, the printable web and the print module in combination comprise a high speed offset printing press. High speed refers to, for example, a linear speed of from about 300 to about 1,200 feet per minute or more.

Print module 12 can comprise a single print engine, or two or more print engines, wherein the plurality of print engines can have the same or different marking technology or capabilities. Thus, for example, a first print engine, such as an offset print engine, can print constant image information, such as CMYK four-color image and text, and a second print engine, such as an ink jet or xerographic print engine, can print variable image information, such as custom color, specialty graphics, production information, customer information, lot or serial numbers, expiration dates, or like image or indicia information. It is understood by those skilled in the art that two or more different print engines can be configured to print on the same side of the substrate, opposites sides of the substrate, or both.

In high volume applications, such as high speed offset printing, the printable substrate can have a relatively wide width and a relatively high speed, such as a width from about sixteen to about forty inches and a linear speed of from about 300 to about 900 feet per minute or more. In other embodiments, for example in lower volume applications such as certain flexography applications, the printable substrate can have a relatively narrow width and relatively slow speed, such as a width of less than about eighteen inches and a speed of less than 400 feet per minute,. In other embodiments, for example in mid-volume applications, the printable web or sheet feeding can have a relatively narrower width and faster speed, such as a width of less than about sixteen inches and a speed of from about 200 to less than about 500 feet per minute. In still other embodiments, for example, high-speed narrow-width offset applications, the printable web can have a relatively narrow width and relatively fast speed, such as a width of less than about twenty inches, and a speed of from about 300 to about 1,200 feet per minute.

The printing and subsequent processing of the printed images, such as cutting and stacking, is preferably monitored and performed with at least one, and preferably four or more, different inspection systems, such as inspection station 25 intermediate feed module 11 and print module 12. One system, a video print inspection system, can aid a system operator or automated controller in the inspection of print quality. Another system, a print registration control, can check and automatically correct the print register. Yet another system, a closed-loop color control, can analyze and adjust ink density according to the pre-defined desired print specifications. Still another system, for example a video die-cut inspection system, can aid the operator in the inspection of web- or fed-sheet cut-quality. The order of inspection stations 25 within system 10 may be rearranged. The use of each of these specific inspections is not required, but the use of all of them can be preferred in various embodiments.

The apparatus and method of the present invention can further include monitoring of the registration of the printing to the cutting. Such monitoring of the registration of the printing to the cutting enables, for example, the elimination of a characteristic telltale white strip or unprinted area artifacts from the printed sheets.

An ability to accurately measure or monitor basic aspects, such as the above mentioned product, process, and operational aspects of the system 10 is frequently facilitated by a pre-defined product or process target specification for quality control or quality assurance. Such target specifications and achievement of the target specifications can provide useful documented “proofs” of the process leading to the product.

Measuring or monitoring aspects of the printing and packaging system, such as mentioned above, can be accomplished, for example, on-line, off-line, or by combinations thereof. The measurements are preferably accomplished on-line using process automation tools, for example positional sensors, video microscopy, or magnification in conjunction with analytic or diagnostic software, for observing and maintaining print, image, color fidelity, cut-to-print registration, print-to-print registration, reproducibility, and like quality parameters. Monitoring the registration of the print-to-cut can be accomplished in one embodiment by continuously detecting by inspection station 25 a reference mark on the web matrix region prior to cutting and continuously adjusting, as needed, the web relative to the cutter, the cutter relative to the web or both (e.g., using web guides, web compensator rollers, and like adjustable components) to achieve a predetermined alignment of the cutter relative to printed items on the printed web. The aforementioned adjustment of the cutter can include, for example, controllably varying the speed of the web, controllably varying the position of the web, continuously adjusting the die-cutter (e.g., circumferentially, laterally, or both) or combinations thereof. Here “predetermined alignment” generally refers to proper alignment needed to achieve target print-to-print and cut-to-print registration specifications. Continuous registration and like adjustments can provide a number of advantages including avoiding problems associated with cutters, such as a guillotine cutter, for example, unreliable or unpredictable dimensional consistency and uniformity, alignment, registration, and like issues. Thus, system 10 can cut each printed sheet individually. The present process and apparatus can also cut a plurality of sheets individually and at the same time.

The following documents disclose or illustrate suitable command and control equipment, monitoring or measurement equipment, or related components or features which, in embodiments, can be adapted for use in-part in the present invention without departing from inventive aspects of the present disclosure: U.S. Pat. No. 5,460,359 discloses a binding apparatus for binding sheets of cut paper printed by a printing machine including a control system; U.S. Pat. No. 4,891,681 discloses a hard copy apparatus for producing center fastened sheet sets including trapezoidal stacks for folded binding, and a control system; U.S. Pat. No. 4,785,731 discloses a bundle count verifier (e.g., for newspaper bundles); U.S. Pat. No. 4,727,803 discloses a conveyor device with an article lifting unit; U.S. Pat. No. 4,566,244 discloses a paper sheet grip and transfer apparatus for a counting and half-wrapping device, see also disclosed therein Japanese Laid-Open Patent Specification No. 57-8616 (transport of paper sheets) and Japanese Laid-Open Utility Model Specification No. 50-98791 (transfer a pile of paper sheets on a belt without holding the sheets on the belt); and U.S. Pat. No. 4,424,660 discloses an apparatus for binding paper sheets stacked within a hopper into bundles each consisting of a predetermined number of paper sheets including a method of sheet transport, for example, sheets sandwiched between belts.

Optional Substrate Coating, Conditioning, or Treatment Module(s)

The method of making can further comprise applying optional coatings, conditioning, and/or treatments. The optional steps can be accomplished inline system 10, out of line system 10, or combinations thereof. If at least one optional step is inline, system 10 and a method of making bundled printed sheets according to the present invention can comprise optional coating, conditioning, or treatment modules 13 and combinations thereof. Optional modules 13 can be located anywhere before or after printing module 12 in system 10. In one embodiment, for example, optional coating module 13a can be configured to apply one or more coatings to either or both sides of the substrate before or after print module 12. After print module 12, the optional coating module(s) 13a-c can be applied to the printed side of the web, the unprinted side of the web, or both the unprinted side of the web and the printed side of the web, depending, for example, on the properties desired for the printed sheets and the bundled printed sheets. Coatings which can be applied to the printed substrate, or prior to printing on the substrate, can include, for example, a varnish coating, a gloss coating, a protective coating, an anti-static coating, an opaque coating for example to conceal printed images beneath such as in some scratch-off game cards, a nitrogen-based UV final coating, an adhesive coating, and like coatings, or combinations thereof. High gloss UV varnish application to a continuous web-based substrate can provide considerable savings, for example, in time, steps, set-up, handling, rework, discards, and like savings.

Optional coating, conditioning, or treatment modules or stations 13 can include, for example, optional inline coaters 13a-c, which can apply, for example, a functional coating to one or both sides of the web. The functional coating can comprise a gloss coat or varnish coat. After leaving coater 13a, the web or sheets can be diverted by re-routing to extend the web's path and to permit satisfactory leveling or drying of the applied functional coating before further processing steps are accomplished. One or more additional inline coating units 13b-c can apply a second or a third functional coating to one or both sides of the web, such as an antistatic or static-preventing coat, a silicone based antistatic coating, and like coatings, or combinations thereof, or other performance or appearance enhancing chemical coats. Antistatic compounds, such as quaternary ammonium salts, and antistatic formulations are known and are commercially available. Coating the web, for example, with varnish or similar materials, can be used to protect or to enhance the appearance of the printed product, such as labels, in some printing embodiments. If foil or laminate print technologies are used, coating with varnish may not be necessary. Optional modules 13 may be integrated into print module 12, and therefore may be provided by a commercial manufacturer. Preferred equipment for use in modules 12 and 13 can be, for example, the model QUANTUM 1250CM press commercially available from Sanden Machine Ltd., of Cambridge, Ontario, Canada. Equipment, processes, and control systems for coating web materials are generally disclosed, for example, in U.S. Pat. No. 4,886,680. In embodiments, optional interstation web chilling modules (not shown) can be employed, for example, after or between each print tower or print station to, for example, remove excess heat, facilitate cure or drying of the printed or coated web, promote proper finishing or surface textures, and like enhancements, such as in a multi-color (e.g., four to fifteen print towers) web offset press using UV curable inks.

In some embodiments, a liner-less adhesive coating is applied by inline coater module 13a to at least a portion of one face of the web or sheet by die extrusion, spray coating, curtain coating, or other coating techniques and combinations thereof. The liner-less adhesive coating can be applied prior to or after print module 12 in embodiments. An adhesive can be applied to the entire surface of one face of the web or sheet, or the adhesive can be applied to a portion of the face to produce repositionable sticky labels, for example. Suitable contact-free process equipment, such as, for example, vacuum belts, vacuum rolls, and the like, can be used to accommodate for the adhesive-coated web or sheet within system 10. Such equipment is commercially available from Gamicott, Ltd. (Toronto, Canada), 3M, and other suitable manufacturers. As discussed below, laser die-cutting reduces dust and debris created in converting and therefore it the preferred method for converting adhesive-coated webs or sheets. In other embodiments, the web or sheet is laminated inline with a conventional adhesive and liner, for example, and other suitable laminates. The web or sheet can be laminated prior to or after print module 12.

A method of making bundled printed sheets according to the present invention can further include a web-chiller module 13d for chilling the printed web. Web chiller module 13d comprises a web chiller or chilling mechanism, such as one or more refrigerated rollers, coolant chilled rollers, cool conditioned air, or like chilling mechanism, which can be non-contact with the web or preferably in-contact with the web, can be employed to cool and thereby stabilize the post-print or post-coat web product and can provide improved registration prior to cutting the web into individual printed sheets. Web-chiller module 13d can be situated anywhere along the web's path within system 10, for example, between the print module and the cutter module, and preferably just after the inline coating station or web coating module. Web-chiller module 13d provides a convenient way to, for example, remove excess latent heat from the web arising from one or more printing operations, UV light exposure or curing, frictional contact with web propulsion or guidance devices, and like sources of heating. Web chiller module 13d can further include a web nip situated between a nip roller and a backing roller, the web-nip preferably being situated just before the chiller in the chiller module 13d.

The apparatus and method can also further include a web guide system for web substrate regulation. An optional web guide system 13e can be employed in embodiments for substrate regulation and to provide improved registration of the printed web presented to the cutting module, such as a die-cutter.

Optional corona chargers or like charging devices, such as charger 23, or discharging devices, such as antistatic bar or static eliminator 26, can be used in system 10 to electrostatically condition or treat the web before or after the print module. Charging the web can, for example, make the web, which may be a plastic film, composite, or laminate-based web, more receptive than otherwise to inks, coatings, or like treatments. Discharging or removing static from the web or from the resulting cut printed sheets can, for example, facilitate sheet transport and stacking by reducing or eliminating sheet charging, like-charge repulsion, and like problems.

Substrate Cutting

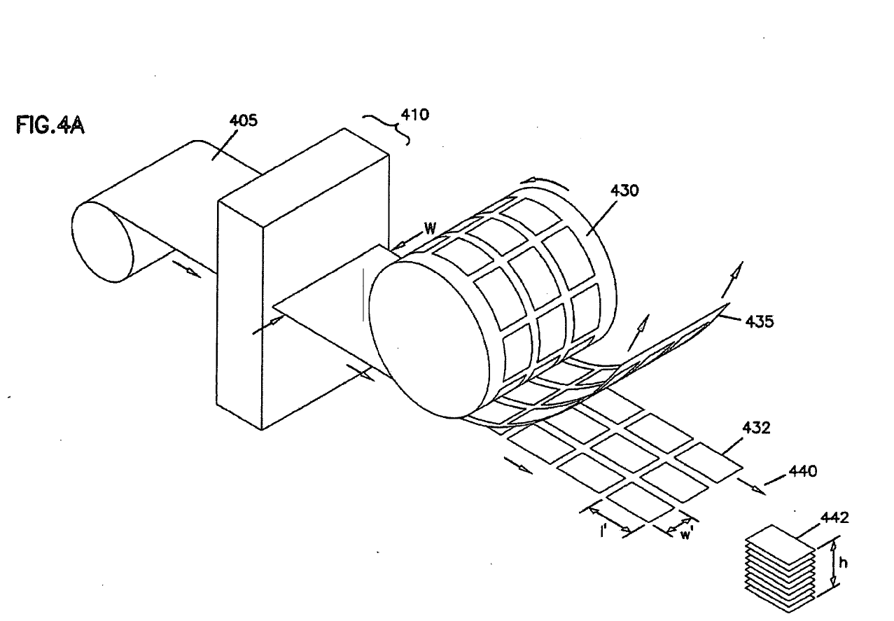

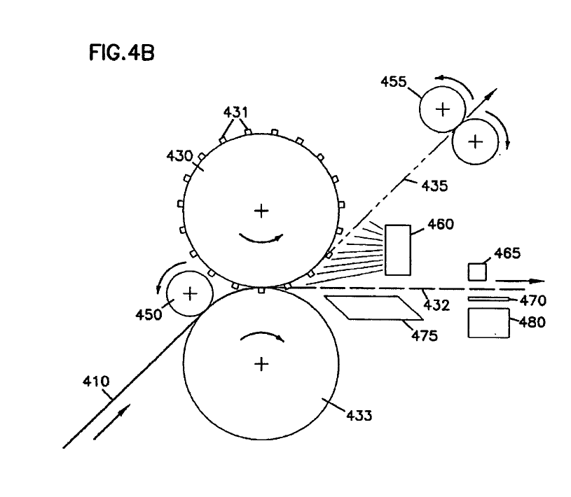

After the web has been printed and optionally conditioned or surface treated, the web is guided to a cutter module 14. Cutter module 14 can include, for example, a laser die-cutter, a rotary die-cutter, a flat-bed die-cutter, a slit-and-gap cutter, a slit-and-butt cutter, a guillotine cutter, and like cutters, or combinations thereof. “Slit-and-gap” cutting generally refers to cutting which is capable of slitting and cutting-out or creating a gap between adjacent sheets or work pieces in the process direction. In one embodiment of the invention, cutter module 14 can include, for example, an inline rotary die-cutting system, which die-cutter can cut individual printed sheets from the printed web to create a corresponding continuous sheet stream and a continuous cut-out waste stream or waste matrix. In one preferred embodiment of the invention, cutter module 14 can comprise a laser die-cutter, which die-cutter can cut individual printed sheets from the printed web or sheet to create a corresponding continuous sheet stream with more precise registration and less cut-out waste stream or waste matrix and debris. A sheet stream generally refers to a continuous or semi-continuous intermediate transport or flow of cut printed sheets from cutter module 14 to further processing. Therefore, a sheet stream and a waste stream, if applicable, originate upon cutting the web or sheet-fed substrate and ceases when the individual cut sheets of a stream are received by a collator and collated into a stack, where collating generally refers to collecting a portion of the cut printed sheets from each sheet stream to form an individual stack of cut printed sheets having uniform geometry or having unitary three-dimensional ordering. Additionally, a sheet stream is formed from successive cutting events in a specific reference location on the web or the same region of successively fed-sheets, which produce a series of cut printed sheets. Cutter module 14 can provide from about two to about eighty streams of printed sheets in one embodiment. Cutter module 14 can further include a web-nip between a nip roller and an anvil roller. This web-nip can preferably be situated just before the cutter in the cutter module as illustrated and discussed in FIG. 4B.

In embodiments in which cutter module 14 comprises two or more die cutters, a first die cutter can be adapted to cut customized details or features from the incipient (not-yet-cut) printed sheets, such as notches, holes, hang tag apertures, concave curves, convex curves, or both, and like geometric or design details, and without severing or separating the printed sheet from the web or fed-sheet. A second die cutter can be adapted to further cut the printed sheets, or completely cut-out individual printed sheets from the substrate. Cutter module 14 can optionally be adapted so that a die cutter cuts the substrate to the desired and defined dimensions for each printed sheet except for a small fiber region or umbilical thread, for example, of about ten to about 1,000 microns, and preferably about 100 to about 200 microns, between the substrate and the sheet, preferably at the lead and trailing edges of the sheet and the substrate. This fine region or thread can momentarily retain the material connection and force continuity between the nearly completely cut printed sheet, inline nearest neighbor printed sheets, the moving substrate, or combinations thereof. An optional edger or slicer can subsequently “burst” or break the umbilical thread at a more favorable location downstream. An optional debris collector, such as a vacuum line or vacuum manifold, can be situated in close proximity, such as from about one centimeter to about 100 centimeters away, to remove potentially objectionable dust and like debris generated from the bursting operation.

Cutter module 14 can also include a static eliminator 26 in one embodiment. Static eliminator 26 can facilitate separation of cut sheets and waste matrix, and prevent the cut sheets from following or adhering to the matrix, the cutter, other sheets, or to the sheet transporter. Methods of static charge or frictional charge suppression or elimination, for use in place of or in conjunction with humidity control, can include, for example, a conductive or non-conductive disturber brush, an air ionizer such as a charge corotron, a de-ionizer, and like articles or devices. Other methods of static charge or frictional charge suppression or elimination, for use in place of or in conjunction with humidity control, can include, for example, applying an anti-static coating or like surface treatment, where for example one or both side of the web or fed-sheets are treated before or after printing.

Inline die-cutting of a printed web to produce individual cut printed sheets, such as printed labels, saves time and lowers cost compared to processing the cut printed sheets or labels individually at various stages. Inline die-cutting can also produce an exact or substantially exact duplication of the cut features in each and every printed sheet produced. In contrast, cutting labels with, for example, a guillotine cutter, can often be prone to operator error or mechanical error (e.g., attributable to cumulative machine wear) which can lead to greater variation and lower quality in the finished product. An inline die-cutting system can provide ideal duplication of specified product dimensions as well as accurate print-to-cut registration. If desired, a cutting module 14 having a die-cutter can be preferably integrated into print module 12, similar to the abovementioned integrated coating module 13. Laser die-cutting equipment for precision die-cutting is commercially available from, for example, Lasex of San Jose, Calif., and Rofin of Detroit, Mich. Rotary die-cutting equipment, such as rotary dies and flexible dies, print cylinders, and other rotary tooling for precision die-cutting, is commercially available from, for example, Rotometrics of Eureka, Mo.; and Bemal Inc., of Rochester Hills, Mich. Various other wide format cutters and related inline finishing equipment are commercially available from, for example, Advance Graphic Equipment (www.advancegraphicsequip.com).

In preferred embodiments, cutting module 14 comprises at least one laser die-cutter. Laser die-cutters provide enhanced features from other inline die-cutters, such as rotary die-cutters. Laser die-cutters exhibit the speed advantages of other inline die-cutters, with increased efficiency. For example, laser die-cutters are configured to cut a specified pattern or patterns by a computer program whereas rotary die-cutters require a separate drum for each individual pattern used in the apparatus and method of the present invention. To change from one pattern to another using a rotary die-cutter, a manual drum or plate change is required, causing machine down-time and increased turn-over time. Laser-die cutters, on the other hand, are run by a computer which is programmed for each cut pattern. Start-up and change over require only a program change, rather than a drum or plate change, decreasing start-up time and turn-around time and increasing efficiency.

The laser die-cutter programs allow a variety of depth of cut, patterns, widths, shapes, and the like. For example, in some embodiments, individual labels in a web or sheets can be cut in the same shape or a variety of shapes, before the labels are collated into a number of stacks. In another embodiment, the individual stacks are cut into a shape or variety of shapes. In yet another embodiment, a first laser cutter is used to cut the web into a variety of labels of the same or different shapes, and a second laser cutter is used to cut the collated stacks into the same or different shapes.

Unlike mechanical die-cutters, such as rotary die-cutters, laser die-cutters do not suffer the drawbacks of dulling, chipped rules, or warping. For example, a rotary die-cutter is made up of steel rules that dull over time, resulting in reduced registration precision and ultimately increased waste due to unacceptable end product. It is also necessary to frequently replace the rules, the drum, or both of the die-cutters, which is costly. With proper cleaning and maintenance, a laser die-cutter will never dull and each cut will virtually be exactly the same dimensions, reducing the cost of dies and processing and improving quality.

Laser die-cutters also reduce the waste compared to conventional die-cutters. Because of the precision and accuracy of laser die-cutters, labels can be butt cut, reducing the gaps between each label required for rotary die-cutters. A matrix is not required and the percent waste is decreased. Therefore, total production costs decrease because product output increases and waste decreases. Laser die-cutters also decrease the debris produced during converting because any debris created is very fine and is incinerated by the laser upon cutting. Therefore, debris-sensitive webs or sheets can be used in the apparatus and method, such as, for example, a substrate with pre-applied or inline-applied adhesive on at least one face of the web.

Laser die-cutters allow use of a number of substrates that may not be viable when using mechanical die-cutters, such as rotary die-cutters. For example, in some embodiments of the present invention, a pre-laminated web, including adhesive applied to at least a portion of one face of the web, is laser die-cut into repositionable sticky labels. The adhesive can be applied inline, before cutter module 14, or the web or sheet stock may comprise pre-applied adhesive in a separate process. The adhesive web or sheets can comprise a liner, such as a silicon liner applied over the adhesive, or can be liner-less. Because the depth of cut can be varied by changes in the computer program, a linered web or sheets can be laser cut so that the liner is cut along with the web, sheets or stacks, or the sheets or stacks can be cut leaving the liner, uncut.

Preferred embodiments of the present invention comprising, for example, a die-cutter, can provide cut printed sheets having a print-to-cut registration (print registration to cut edges variance) from less than or equal to about plus or minus 0.0625 inches ( 1/16th), more preferably from less than or equal to about plus or minus 0.046875 inches ( 3/64th), even more preferably from less than or equal to about plus or minus 0.03125 inches ( 1/32nd), and even still more preferably less than or equal to about plus or minus 0.015625 inches ( 1/64th). Embodiments comprising a rotary die-cutter can routinely provide cut printed sheets having a print registration to cut edges variance of less than or equal to about plus or minus 0.03 inches, for example. Embodiments comprising a laser die-cutter can routinely provide cut printed sheets having a print registration to cut edges variance relatively similar to the variances provided by rotary die-cutters as described herein above. The apparatus and method of the invention which employ, for example, a rotary die-cutter can provide cut printed sheets such that each sheet has substantially the same length and width dimensions as substantially all the other cut printed sheets produced in the job, for example to within a variance of less than or equal to about 0.010 inches ( 1/100th), more preferably less than or equal to about 0.0075 inches ( 1/133rd), even more preferably less than or equal to about 0.00666 inches ( 1/150th), and even still more preferably less than or equal to about 0.005 inches ( 1/200th). Preferences for the above-mentioned narrower print-to-cut registration variances and narrower length and width dimensional variances will be readily appreciated by one of ordinary skill in the art and can include, for example, higher quality printed sheets, higher stack and bundle uniformity and quality, greater latitude for print layout, artwork, sheet design, and sheet geometry, greater intermediate-user and end-user customer acceptance, greater reliability in methods of application of the printed sheets to articles, greater ease-of-handling and ease-of-use, and like intrinsic and extrinsic benefits.

Various embodiments of the apparatus and method of the invention which include, for example, a rotary die-cutter can provide cut printed sheets and in corresponding bundled printed sheets where each cut printed sheet produced can have a cut-to-print registration variance of, for example, from less than or equal to about 0.0625 inches, and the same length and width dimensions as the other printed sheets in the stack to within a variance of less than or equal to about 0.010 inches. The apparatus and method of the disclosure which employ, for example, a rotary die-cutter can provide cut printed sheets and corresponding bundled printed sheets where each cut printed sheet produced can have both a cut-to-print registration variance of, for example, from less than or equal to about 0.046875 inches, and the same length and width dimensions as the other printed sheets in the stack to within a variance of less than or equal to about 0.0075 inches. The apparatus and method of the disclosure which employ, for example, a rotary die-cutter can provide cut printed sheets where each cut printed sheet produced has both a cut-to-print registration variance of, for example, from less than or equal to about 0.03 inches, and substantially the same length and width dimensions, for example, to within a variance of less than or equal to about 0.005 inches, as substantially all the other cut printed sheets in a job, for example, over a twenty-four to forty-eight hour period, or more, of continuous production or apparatus operation. Variances as described herein can be determined by any suitable measurement methods, including, for example, video microscopy, microscopy with a calibrated vernier or reference standard, a micrometer, and like measurement methods known to those skilled in the art.

Each cutting event of the printed web can be accomplished, for example, widthwise across the web process direction or in a variety of alternative schemes. Alternatively or additionally, the cutting can be accomplished simultaneously or semi-simultaneously with a die-cutter. The die-cutter can cut printed sheets from the web in a variety of ways, such as web printed items which are, for example, aligned adjacent sheets, staggered adjacent sheets, angle-cut adjacent sheets, or combinations thereof. Angle-cut printed sheets are cut from the web or from fed-sheets at an angle other than square to the process direction, such as where at least the edges of the printed sheets approximately parallel to the process direction are cut at a slight angle to parallel. Alternatively, angle cutting of printed sheets from the web or from fed-sheets can be accomplished where at least the lead and trail edges of the printed sheet normal (perpendicular) to the process direction are cut at a slight angle to normal. In one embodiment, the printed sheets preferably are angle-cut on both parallel edges and the lead and trail edges. In embodiments, die-cutting of printed sheets can be accomplished simultaneously, having stagger between or among adjacent latent or incipient streams of printed sheets. In some embodiments, die-cutting can be accomplished with angle-cutting of one or more of the edges of the printed sheets. Angle-cutting the web- or fed-sheets produces sheets which can be, for example, square-shaped or rectangle-shaped and can optionally have square corners of about ninety degrees. These sheets are cut by a die that has a minor skew angle or orientational off-set of the cut edges from parallel, perpendicular, or both, relative to the process direction edges of the web, so as to allow the rotary die cutter to achieve cuts which provide more shear-type cut forces and minimizes or eliminates “bounce” or recoil associated with simultaneous cutting of like pieces from the moving web at high speeds. Thus, in angle-cut die-cutting, the die-cut blade is preferably slightly skewed by, for example, about one-half of a degree so that the lead edge of each die-cutting blade provides web cross-cut action from a point and proceeds in a line rather than a perpendicular “all-at-once” cut normal to the edges of the web or the fed-sheet.

Die-cutting of the printed web can be configured to continuously produce a stream of printed sheets from a corresponding width of the printed web. Die-cutting is preferably accomplished in a continuous fashion, for example, without hesitation or interruption in the speed or movement of the printed web or printed fed-sheets. The preference for continuously die-cutting is evident from, for example, measured economic efficiencies, product throughput, and minimized or minimal operator intervention. In one embodiment, each die-cutting or die-cut event can be accomplished in one of several alternative schemes or variations on the schemes and combinations thereof, for example, “simultaneous” die-cutting wherein the lead edge of each sheet of an array of printed pieces on an advancing web or a fed-sheet substrate is first cut by a suitably adjusted and configured die-cutter. The die-cutting continues to cut out the printed pieces from the web or the fed-sheets arriving from an upstream process direction to generate individual printed sheets or an array of individual printed sheets across the process direction. In embodiments of the presently disclosed methods of making bundled printed sheets, each cutting event can produce, for example, from one to about eighty individually cut and printed sheets width-wise across the web process direction, depending on, for example, the desired (x- and y-) dimensions of the resulting cut printed sheets and bundles.

Cutter module 14 can be configured to have one or more cutters, such as two or more laser die-cutters in series, a laser die-cutter and a rotary die-cutter in series, two or more rotary die-cutters in series, and combinations thereof for cutting the printed web or printed fed-sheets, for example, where it is necessary or convenient to accomplish multiple cuts or special-effect cuts on or within a single sheet, such as “doughnut hole” or “window” cut-outs within a sheet, notches on the edge of a sheet, and like cuts, or combinations thereof. Alternatively, a single cutter, such as a laser-die having an appropriately configured program, or a rotary die-cutter having an appropriately configured die, can often accomplish many, if not most, examples of multiple cuts or special-effect cuts on each sheet with a single die-cut pass or impression.

The system and apparatus of the present invention can further comprise a debris collector situated near, such as about 0.1 inch to about thirty-six inches from cutter module 14. The debris collector can be, for example, a vacuum take-off or manifold, a non-contact tacky-surface roller, a contact tacky-surface roller, a disturber brush member, or combinations thereof. The debris can be, for example, ambient dust or dust created from the cutting, web- or sheet transport, printing, coating, treating, jogging, and like manipulations of the substrate, before or after cutting. Thus, the method can further include removing debris, such as paper or plastic dust or cuttings already present on the web or fed-sheets or generated from cutting or manipulating the web- or fed-sheets into cut printed sheets. Automated label-side cleaning can also be incorporated to remove dust and debris before further processing.

Matrix Removal, Sheet Conveyance, and Sheet Collation

The abovementioned waste matrix or residual web skeleton can be optionally continuously removed and discarded with a waste matrix management module 15, which may comprise a vacuum take-off or a windable take-up reel in one embodiment, although other waste collection or disbursement methodologies may also be used. A vacuum take-off is generally preferred since it can provide higher capacity waste matrix removal, continuous operation, and enhanced safety and handling convenience by directing the waste to an area away from production. After the web is cut the transport integrity of the original web no longer exists thus the resulting cut printed sheets preferably need to be individually, continuously, and orderly transported to a sheet stacker in collator module 16 in one or more cut printed sheet product streams. Each cut sheet product stream can be transported to the sheet stacker or “batch stacker” with a sheet delivery system employing, for example, opposing belts, rollers, vacuum transporters, and like apparatus, or combinations thereof. Examples of preferred suppliers of commercially available equipment for waste matrix removal module 15 include Quickdraft of Canton, Ohio; and individual sheet delivery or transport systems and sheet stackers include, Gannicott, Ltd. of Toronto, Ontario, Canada. See also U.S. Pat. No. 4,102,253.

In one embodiment, collating can be accomplished with a sheet transport and stacking machine which has been suitably modified to receive and collate multiple individual cut printed sheets of one or more sheet streams at the same time. Each stream of printed sheets can be transported from the cutter to the collator with a sheet transport system comprised of at least one transport belt and at least one backing roller opposing the transport belt. Individual sheet transport, alternatively or additionally, can be accomplished with a vacuum assist transfer machine as disclosed, for example, in U.S. Patent Application Publication No. 2003/0164587 to Gronbjerg.

The sheet delivery system preferably is adapted to simultaneously transport a plurality of the cut sheets in adjacent parallel sheet streams. At the sheet stacker, the individual sheet delivery system feeds the respective sheet streams, containing the cut printed sheets, into bins to form respective stacks. The stacks can be collectively or individually customized with respect to, for example: stack dimensions and the number of stacks formed based, for example, on cutting criteria, and the number of printed sheets in each stack. Stack dimensions can depend on, for example, sheet thickness, sheet-count, stack-height, stack-weight, or like criteria. In embodiments, sheet-count is a preferred stack customization criterion, which is typically driven or determined, for example, by customer use requirements and ergonomic handling factors. Stack customization criteria can be readily translated and programmed into the apparatus and production process of the disclosure by appropriate manual or automated, adjustment or modification, of the process equipment, controls, or both, such as replacing the die-cutter plate to provide customized cut sheet dimensions, reprogramming the sheet counters or stack height sensors to customize the stack height, adjusting sheet alignment tolerance within each stack, and like changes. When stack customization criteria and related quality criteria, such as print quality, are fulfilled in production, the resulting stack can be deemed to be “registered” and those stacks are acceptable for further processing within the apparatus. “Unregistered” or out-of-register stacks can optionally be identified, marked, rejected, such as removed from the product stream, or like remediation, at this or later points in the apparatus or production process and analogously to the abovementioned removal of individually rejected cut sheets from the sheet stream transport. The collator can provide from about two to about eighty registered stacks corresponding to the number of collated sheet streams in one embodiment.

In one embodiment, the cut printed sheet transport system can be adapted, in conjunction with known or the abovementioned command and control equipment, to reject cut printed sheets which do not have substantially the same cut-to-print registration, sheet dimensions, or both attributes, as all other sheets in the job. The cut-to-print registration, sheet dimensions, or both specifications can preferably be established manually or programmably during job set-up or can be called-up from a computer or controller's memory. Rejected or out-of-spec cut printed sheets can be readily diverted and removed from a sheet stream at a point between the cutter and the collator, for example, by a sheet grabber or a sheet diverter.

In embodiments of the present disclosure, the collator module for the cut sheet stream can alternatively be a rotary sorter as disclosed, for example, in U.S. Pat. No. 4,582,421 (copying machine with rotary sorter and adhesive binding apparatus), appropriately modified to receive multiple sheet streams into multiple stacks. In various embodiments, such a rotary sorter can be further optionally adapted to receive and further transport the stacks to the conveyor module, with inversion of orientation or optional retention of stack orientation upon delivery to the conveyor module.

Stack Conveyance

A conveyor module 17 can be adapted to receive, for example in continuous batches, one or more registered stacks from the collator module and to convey each registered stack, in batches, into a stack stream. A stack stream is generally a continuous or semi-continuous transport or flow of registered stacks from the collator to further processing. The conveyor module can convey from two to about eighty registered stack streams into a single stack stream in one embodiment. Alternatively, the conveyor module can convey from two to eighty registered stack streams into two stack streams in another embodiment. Conveyor module 17 conveys (e.g., in the web process-direction) the registered stacks away from collator module 16 on a first conveyor for a distance to further processing, such as packaging. Conveyor module 17 conveys the registered stacks away from the collator (e.g., in the web process-direction) for a distance on a first conveyor and thereafter the registered stacks can be displaced laterally or perpendicularly (i.e., with respect to web-process direction) onto a second conveyor to form a merged stack stream. A stack stream as used herein can arise from, for example, a plurality of registered stacks being merged into a single stream of stacks. In embodiments, a stack stream can also arise from, for example, bifurcating or splitting the abovementioned merged single stream of stacks into two or more stack streams. A plurality of stack streams can also arise from, for example, bifurcating or splitting the registered stacks soon after being formed, into a plurality of stack streams.

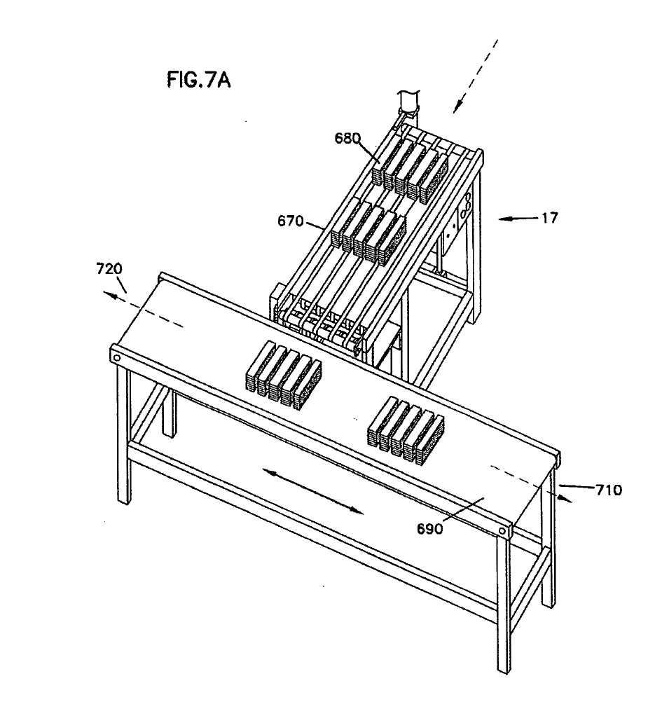

A single conveyor, for example, oriented perpendicular to the sheet stream flow and the incipient batch stack formation, and situated in close proximity to each batch stacker can be adapted to directly receive the cut printed sheets and incipient stacks. Thus, the conveyor surface, when stationary, can serve as the base of the batch stacker where the sheet streams are compiled into stacks. Thereafter, the completed registered stacks are intermittently conveyed from the batch stacker to subsequent packaging modules in a single stack stream. This single conveyor configuration eliminates the need for two conveyors to get to the first packaging module, such as the first conveyor as depicted in FIG. 7 and described in more detail below, since a preferred stack stream merger into a single stream can be accomplished as the stacks are formed and there is no need to extend or “turn-the-corner” with a hand-off to a second conveyor.

Conveyor module 17 transports the stack stream or streams to and through the remainder of the apparatus and process modules of system 10. The stacks can be transported unsupported to subsequent stages of production without damaging or disturbing the integrity of the unsupported stacks. “Unsupported” means that accessory support or supplemental structural materials, such as sheets of cardboard, chipboard, stiffener sheets, or the like, are not necessary to maintain side-to-side registration or shape, such as “squareness” or verticality of the stacks for square, rectangular, or irregularly shaped sheets. Various conventional belt-driven conveyor systems are known, available commercially, and suitable for this purpose and as illustrated herein. Alternatively or additionally, conveyor module 17 can have a belt or equivalent conveyor means equipped with stack or bundle supports which are external to the bundle, for example, one or more tractor blades, fins, cleats, ribs, sidewalls, “one-way grass,” mole skin, and like rigid or resilient structures or textures, or combinations thereof, and which supports can be integral with (e.g., molded) or affixed to the conveyor, and optionally can have a hinge. Conveyors having external supports are widely commercially available.

Conveyor module 17 can comprise an endless belt, such as one or more belts, or like transport devices. In one embodiment, conveyor module 17 can comprise a first conveyor having two over-under parallel endless belts and an elevator, and a second conveyor, wherein the two over-under parallel endless belts each carry a stack stream from the collator to the second conveyor, the elevator being operable to alternate the position of the two over-under parallel endless belts relative to the collator and the second conveyor. Conveyor module 17 can be configured so that each stack stream on the first conveyor is merged or combined into a single stack stream on the second conveyor. Other suitable conveyor module configurations are available and can depend on, for example, convenience, throughput, cost of operation, cost and speed of packing equipment, and like considerations. Thus, in one configuration, a second conveyor can convey the stack stream uni-directionally to the packaging module. In another alternative configuration, the second conveyor can convey the stack stream bi-directionally to two separate packaging modules, that is, the merged stack stream on the second conveyor provides two stack streams alternately flowing in opposite directions from the second conveyor to two separate pack lines, as illustrated and discussed in FIG. 7.

Bundle Formation and Packaging

Packaging each registered stack in the stack stream to form a bundle of printed sheets can include optional banding, overwrapping, optionally shrink-wrapping the applied overwrapper, stretch-banding, or combinations thereof. Packaging can include, in the order recited or in other sequences according to various embodiments of the invention, an optional first banding station, a second over-wrapping station, and an optional third shrink-wrapping station. Alternatively, packaging can include applying a band to each stack, placing one or more banded stacks in a container, and sealing the container. In one embodiment, packaging can include over-wrapping at least one stack, placing one or more over-wrapped stacks in a container, and sealing the container. If desired, the packaging can be accomplished by simply banding the stacked printed sheets.

A function of the band is to maintain the integrity and order of the stack to, for example, facilitate subsequent packaging steps if any, improve ease and quality of the dispensed printed sheets at the point of use, such as a label application operation or facility. Surrounding a registered stack with a band can be accomplished in many ways, for example, wrapping an end of a continuous band around the stack to size the band, cutting the sized band, and fixing the ends of the band to form a continuous or semi-continuous band, such as by gluing, welding, thermal fusing, dimpling, crimping, and like methods for forming a band or flexible holder about at least a portion of the stack. Alternative banding approaches can include, for example, inserting the registered stack into a pre-formed banding sleeve and optionally shrinking the sleeve, wrapping a pre-cut band around the stack and fixing the ends of the band, and like banding methods. Bands can be made of any suitable material, for example, rubber, plastic, paper, string, adhesive tape, non-adhesive tape, overwrap film, and like materials, or combinations thereof. If desired and for reasons disclosed herein, the packaging can be accomplished by placing two or more bands around a registered stack. The packaging can also be accomplished by placing one or a single band around a registered stack.

In some embodiments, conveyor module 17 transports and feeds unsupported stacks through an optional bander module 18, which applies at least one band around each stack to form a banded stack. Banding is often a requirement for proper and convenient handling of stacks by an end-user of the printed sheets, such as a label applicator concern. Banded stacks may also be conveyed in the packing portion of the apparatus at higher speeds than without banding. A commercial supplier of equipment for a bander module is, for example, Sollas Holland BV of Wormer, The Netherlands. The Sollas model AB50 banding machine is a preferred example.

Banding is not, in general, a requirement of the process or apparatus of the disclosure. In some embodiments, banding is not required, allowing unsupported stacks to be over-wrapped individually or in groups, unsupported. Unbanded stacks can reduce turnover time in the current process by eliminating the banding station, for the end user of the bundled stacks, or both. Often times, unbanding the bundles requires manual labor adding cost and time to the labeling process. Therefore, unbanded stacks are often preferred.

Conveyor module 17 next optionally conveys the stacks, banded or unbanded, through an overwrapping module 19, which wraps each registered stack of printed sheets in an easy-to-peel overwrap film. The second step of packaging can be accomplished by over-wrapping each registered stack, banded or un-banded, to form a wrapped stack or bundle of printed sheets. Over-wrapping of each registered stack can form a sealed enclosure about the entire stack. Over-wrapping can provide an important environmental barrier which protects the printed sheets from, for example, moisture, spills, humidity changes, dust, pollutants, and like contaminants, which can damage or detract from the aesthetics or performance properties of the printed sheets in downstream commerce applications, such as labeling operations, label appearance, label performance, and consumer acceptance. Overwrapping can prevent problems associated with handling or manipulating exposed printed sheets in subsequent processing. Overwrapping can also protect the bundled printed sheet product from moisture and humidity, especially after the product leaves the label manufacturer. Although preferably produced in a stable environment, the bundled printed sheets, such as for label application, may be shipped into substantially different climates, for example, a dry canning factory in New Mexico where ambient humidity at the application site may less than about 10-30%, or a water bottling plant in Oregon where ambient humidity at the application site may exceed 60%. The overwrap preferably is not removed from the wrapped bundle until just prior to application, so that exposure of the labels to the ambient environment is minimized to, for example, as little as fifteen minutes or less.

Overwrapper module 19 can be adapted to overwrap two or more banded or unbanded stacks if desired. Over-wrapping can be accomplished with any suitable wrapping material such as plastic, synthetic or natural films, such as cellophane, acetate, polyvinyl acetate, and like materials. Suitable films include those supplied by RTG Films of Chalfont, Pa. A commercial supplier of preferred equipment for an overwrap module is, for example, Sollas Holland BV. The Sollas model 20 wrapping machine is a preferred example. Other commercial suppliers of overwrap equipment includes Marten Edwards and Petri, see Linfo Systems Ltd., mentioned below, which machines can be adapted to overwrap from between 100 to 265 pieces (bundles) per minutes.

The method can further include, for example, placing the resulting bundled printed sheets, banded or unbanded and overwrapped or unwrapped, in a suitable container. In some embodiments, conveyor module 17 can deliver the resulting stacks, overwrapped or unwrapped, to an optional containerizer module 20 where, for example, a programmable industrial grade robot, a manual operator, or like devices can be programmed to pick-and-place the stacks or bundles of printed sheet product, banded or unbanded, overwrapped or unwrapped, in a suitable container, such as cardboard boxes or like suitable containers, and sealing the box with tape.

The method can further include placing a number of the sealed containers on a carrier, such as a pallet or skid for convenient handling and shipping, and optionally stretch-banding the collected sealed containers into secure monolith for transport or storage. The method can also include, for example, further collating the bundled printed sheets into larger or secondary bundles (bundles of bundles), having for example from about two to about twenty primary bundles, and which secondary bundles can also be optionally overwrapped, shrink-wrapped, stretch-banded (with e.g. polyethylene or like materials), and like packaging, or combinations thereof to complete the packaging or optionally further containerized.

Containers can be, for example, cartons, boxes, bags, cans, drums, supersacks, cargo-tainers, and like articles. The container can be made from, for example, cardboard, wood, plastic, metal, or like materials of construction. The container can include, if desired, a sealable liner, such as a plastic bag or like membrane, which protects the bundled printed sheets packed in the container. Thus, the banded or unbanded stacks without an overwrapper but contained and sealed in the container with a sealable liner can resist changes in humidity and like potentia environmental or external effects.

Containerizer module 20, such as a boxing station, can be adapted to wrap a container material around a plurality of bundles (bundle of bundles), such as cardboard stock or plastic, to form the container inline. Inline container formation has a number of advantages including just-in-time container generation, automatic or robotic handling, reduced space requirement for containers prior to filing, and like advantages. An optional seal module 21 can be used to, for example, apply a tape seal to the containers containing the bundled printed sheets. The sealed boxes can then be optionally placed, manually or robotically onto, for example, pallets or skids at an optional carrier module 22 for staging, shipping, or delivery to a customer or warehouse. Commercially available equipment from manufacturers of various conveyer systems, parcel handling systems, or robotic systems can be readily adapted for the boxing, sealing, skidding, or like packing operations. For examples of commercial suppliers and details of fully automatic and customizable sheet feeders, overwrap equipment, shrink-wrap equipment, shrink tunnels, bag sealers, and like secure packaging equipment, see Linfo Systems Limited, of Toronto, Ontario, Canada (www.linfo.ca).

The package can comprise a bundled printed sheets comprising: a plurality of printed sheets in a stack; an optional band around the stack; and an optional overwrapper on the banded stack, each printed sheet having a narrow cut-to-print registration variance, for example, of from less than or equal to about 0.03 inches, and each printed sheet having the same length and width dimensions as the other printed sheets in the stack to within a variance of less than or equal to about 0.005 inches; and a container for the bundled printed sheets. The package can further comprise a plurality of the containers on a pallet, the plurality of containers optionally being partially overwrapped with an overwrapper.

The system and apparatus can further comprise an ambient humidity control system, for example, having a localized spray or mist nozzle or having a large scale humidity environmental control systems capable of ambient humidity control over one or more production systems or modules of the disclosure. Although not required the method of making bundled printed sheets is preferably accomplished in a controlled environment, such as where ambient humidity and temperature can be regulated, to safe-guard the quality of the processes and the products. Ambient humidity generally refers to the humidity of the immediate atmosphere, which surrounds the apparatus, particularly in the cutting and stacking operations where static charge, frictional charge, or streaming charge generation or accumulation may occur. The methods of making bundled printed sheets of the disclosure can be accomplished over a range of relative humidity conditions although very low humidity conditions, such as below about twenty-five percent are contraindicated, especially in the absence of alternative methods of static charge suppression or elimination in web-based production systems. The sensitivity of the methods of making to ambient humidity can depend upon many factors, such as temperature, barometric pressure, operating speed(s), web or sheet substrate type selected (e.g., paper, plastic, etc.), the printing inks selected and the amounts applied, coating or other treatment formulations selected and the amounts applied, and like considerations. A suitable relative humidity range for use in the methods of making which employ a paper web or paper fed-sheets is, for example, from about fifty to about eighty percent, and a preferred relative humidity range is from about sixty-five to about seventy-five percent. Methods for controlling ambient humidity are known, such as HVAC climate-controlled facilities, local application of a humidifier, intermittent water-mist sprayers, and like humidification methods. It will be readily understood by one of ordinary skill in the art that the humidity requirements and humidity sensitivity of the apparatus and process of the disclosure can depend upon the print engine or print technologies selected and can even depend upon the different configurations of the same print engine. For example, high-speed offset methods generally tend to favor higher humidity conditions while xerographic methods generally tend to favor lower humidity conditions. The apparatus and method of making of the disclosure are preferably maintained at, or accomplished at, an ambient temperature of from about fifty to about ninety degrees Celsius.

Advantages of the apparatus and process of making bundled printed sheets of the disclosure includes overall accelerated production speed and increased volume throughput compared to known production processes for bundled printed sheets. The total time required between, for example, printed sheet formation (at module 11 to module 14 in FIG. 1) and application of packaging materials (at module 18 to module 22 in FIG. 1) is greatly decreased to less than about one to about four minutes. For example, in current high volume printed label production systems, considerable time passes, such as from about six to about forty-eight hours or more, from the time the labels are printed and until the time the labels are packaged, such as boxed, because of the need for inks or coatings to properly dry or cure. Such time lapses can increase the likelihood that moisture will evaporate from, or penetrate into a printed sheet and potentially cause print quality or handling issues for individual sheets in use.

FIG. 2 depicts an alternative sheet-fed based apparatus 200 for making the bundled printed sheet articles of the present disclosure. Apparatus or production system 200 of FIG. 2 is an automated sheet-fed based system for high volume production of individual printed sheets cut from the fed-sheets in accordance with the present disclosure. Sheet feeding module 210 can be, for example, a sheet-feeder capable of loading pre-cut sheets and which pre-cut sheets are further cut to size. Sheet-feeder devices are known and commercially available and can be readily adapted for use in the apparatus and process of the present disclosure.

The feed-sheets can be either unprinted or pre-printed. In either instance, the feed-sheets can be further processed including, for example, charging, printing, coating, treating, drying, chilling, and like processes, or combinations thereof, analogously to the web-based system of FIG. 1 described above, such as embodied by the aforementioned apparatus and processing associated with modules or components of 12 to 22, 23, 25, and 26. Thus, for example, prior to cutter module 240 there can be incorporated an optional print module (not shown) having a print engine suitable for printing on the fed-sheets, simplex or duplex, or like printing equipment. In one embodiment of the sheet-fed apparatus, the sheet-feeder and the print module in combination can comprise, for example, a high-speed sheet-fed print engine. Similarly and optionally available for incorporation into the system of FIG. 2, but not shown, are modules or stations corresponding to those shown or mentioned for optional modules 13(a-e) in FIG. 1. Other modules schematically shown in FIG. 2, include a matrix removal module 250, a discharging device 255, such as antistatic bar or static eliminator which can be use to electrostatically condition or treat the web before or after the print module, collating module 260, conveyor module 270, banding module 280, overwrapping module 290, containerizing module 291, labeling module 292, optional sealing module 293, and carrier module 294. It will be readily understood that conveyor modules 17 and 270 in FIGS. 1 and 2 and as described herein, are not limited to a single linear conveyor as schematically illustrated in FIGS. 1 and 2. A sheet-fed or discontinuous printing and finishing system employing, for example, a xerographic imager and a vertical collating bin array for sheet stacking or sorting, is disclosed for example, in U.S. Pat. Nos. 4,444,491, and 4,368,972. Commercial suppliers of automatic and customizable sheet feeders, and like paper handling equipment or accessories include, for example, Xerox Corp., Hewlett-Packard Corp., and Canon, Inc.

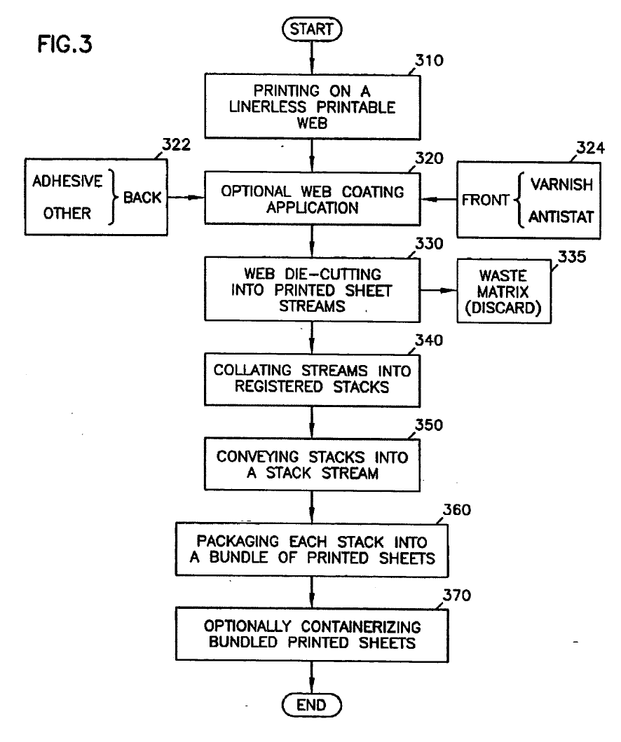

FIG. 3 depicts a block diagram overview of a web-based process for preparing bundle printed sheets of the present disclosure, with for example the apparatus illustrated and described in FIG. 1. For example, printing 310 can be on, for example, a liner-less printable web, followed by optional application of a web coating 320, for example an adhesive or other suitable coating material 322 to one side (e.g., back-side) of the web, and a varnish or antistatic coating material 324 to the other side (e.g., front-side) of the web. The printed and optionally coated web can be preferably die-cut 330 into one or more printed sheet streams with any accompanying waste matrix being discarded 335. The printed sheet streams are collated 340 into registered stacks, the stacks are conveyed 350 into one or more stack streams, and each stack is packaged 360 with one or more packing materials or steps into a bundle of printed sheets. The packaged bundle of printed sheets can optionally be further containerized 370 or packaged, for example, with a banding machine, an overwrapping machine, a heat-shrink machine, a containerizer machine (e.g., a box maker or box loader), a stretch banding machine, a palletizer, and like operations and devices, or combinations thereof.

FIG. 4A depicts a perspective of a portion of a web-based apparatus for preparing bundle printed sheets including, for example, a web-based substrate feeding 405, a printing module 410 which can include, for example, one or more or a plurality of print engines or print towers having the same or different print technology (e.g., offset and inkjet), one or more coating or treatment stations such as UV light cure of printed inks or coatings, or combinations thereof, a drum mounted die-cutting module 430, waste matrix generation and removal 435, resulting individual cut printed sheets 432 the linear flow of which comprises a printed sheet stream 440. Collation (not shown) of a portion of the printed sheet stream provides a registered stack 442. “W” represents the width dimension of the web, “w” represents the width dimension of one or more cut printed sheet, “l′” represents the length dimension of the cut printed sheets, and “h” represents the height dimension of a registered stack. It is readily apparent that W is greater than w′ even when only a single w′ sheet is cut from across the web using a die-cutter which also generates a waste matrix. It is also readily apparent that w′ can be greater than, less than or equal to l′.

FIG. 4B illustrates in embodiments, a section view of a cutter module in a web-based apparatus for preparing bundle printed sheets of the present disclosure including a web substrate feed 410, a rotary die-cutter including a drum 430 having readily interchangeable die-cutting elements 431, juxtaposed die anvil 433, optional juxtaposed nip roller 450, nip roller pair 455, and optional non-contact separator device 460. In operation the cutter module configuration of FIG. 4B provides enhanced performance and process reliability having, for example, reduced jams, complete separation of cut sheets 432 from the waste matrix 435, reduced cut sheet “fly-away,” and like enhancements. Juxtaposed nip roller 450 ensures reliable substrate feed to the cutter. Nip roller pair 455, having for example cutter synchronized and regulated speed, provides a controlled constant tension and pull force to facilitate removal of the waste matrix from the separation area and delivery to a matrix take-off (not shown). Separator device 460 can be, for example, a static charger, a static eliminator, an air knife, a fan, and like devices, or combinations thereof. A preferred combination for use in the separator device 460 is a static charger and an air jet, which combination disperses electrostatic charge to the separation region between the cut sheet and the matrix. Although not desired to be limited by theory, the combined action of the mechanical forces of the air jet, nip roller pair 455, and the electrostatic repulsion of like-charged surfaces or charge neutralized surfaces of the waste matrix and the incipient cut sheet appear to facilitate smooth and reliable separation between the cut sheets and the waste matrix. The cutter module of FIG. 4B can optionally include a bottom-side vacuum transport belt 475 to transport or assist in the transport of cut printed sheets to down stream processing, such as stacking. The cutter module of FIG. 4B can also optionally include a debris disturber 465, such as an air knife or like non-contact device to assist in the removal of debris from the cut printed sheet products prior to stacking. The cutter module of FIG. 4B can also optionally include an abrader or sander article 470, such as a metal plate or sheet coated with a high durability abrasive material affixed to the surface of the article, for example, carbide particles, carborundum particles, diamond grit, sand, and like abrasive materials, or combinations thereof, to further assist in the removal of debris from the cut printed sheet products, and optionally buffing the printed sheet, prior to stacking. The cutter module of FIG. 4B can include one or more debris disturber 465, such as an air knife, one or more abrader or sander article 470, and one or more debris removal device, such as a vacuum collector manifold 480. In a preferred embodiment, the cutter module of FIG. 4B can include a debris disturber 465, such as an air knife, an abrader or sander article 470 for each sheet stream, and at least one debris removal device, such as a vacuum collector manifold 480. The cutter module of FIG. 4B can optionally include the abovementioned components for accomplishing bursting, such as an edger or slitter (not shown) and debris removal device such as a vacuum collector manifold 480. The foregoing web-based embodiment of FIG. 4B can adapted for use in a sheet-fed based apparatus and process embodiments of the present disclosure.

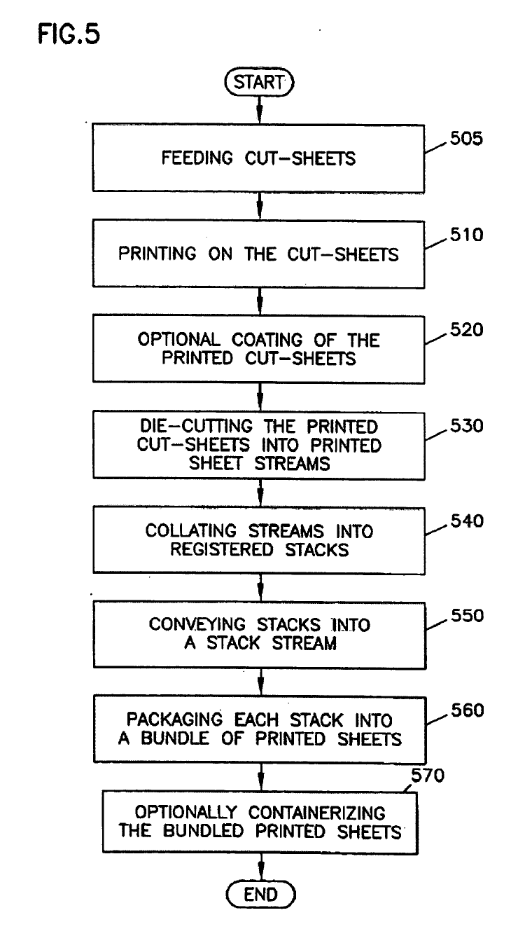

FIG. 5 depicts a block diagram overview of a sheet-fed based process for preparing the bundle printed sheets of the present disclosure, with for example the apparatus illustrated and described in FIG. 2. For example, feeding cut-sheets 505, followed by printing 510 can be on, for example, a plain or bond cut sheet paper stock, followed by optional coating 520 on either or both sides of the printed cut sheets, for example, an adhesive, varnish, antistatic, or like coating materials. The printed and optionally coated sheets can be die-cut 530 into one or more printed sheet streams. The printed sheet streams are collated 540 into registered stacks, the stacks are conveyed 550 into one or more stack streams, and each stack is packaged 560 into a bundle of printed sheets. The packaged bundle of printed sheets 560 can optionally be further containerized 570 or packaged, for example, with a banding machine, an overwrapping machine, a heat-shrink machine, a containerizer machine (e.g., a box maker or box loader), a stretch banding machine, a palletizer, and like operations and devices, or combinations thereof.

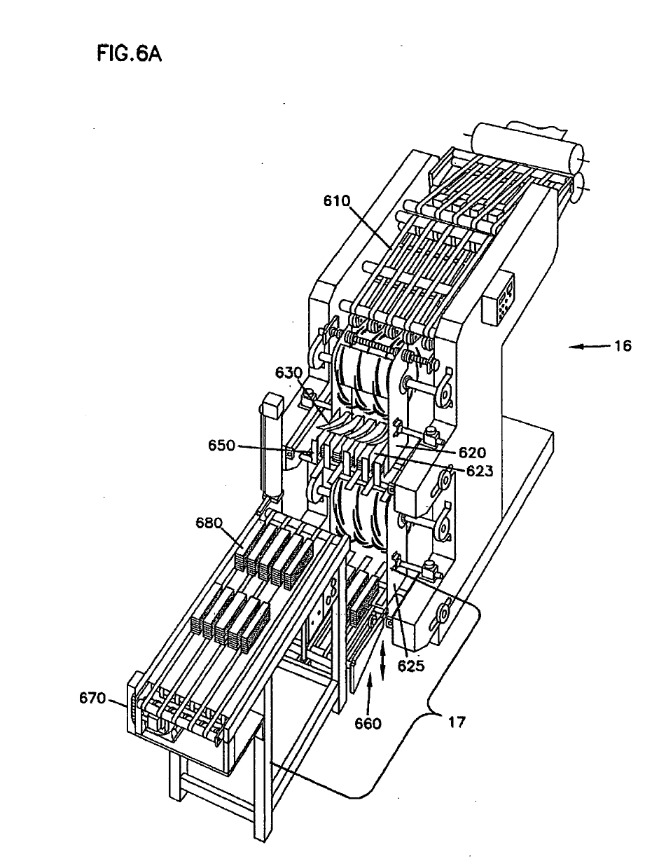

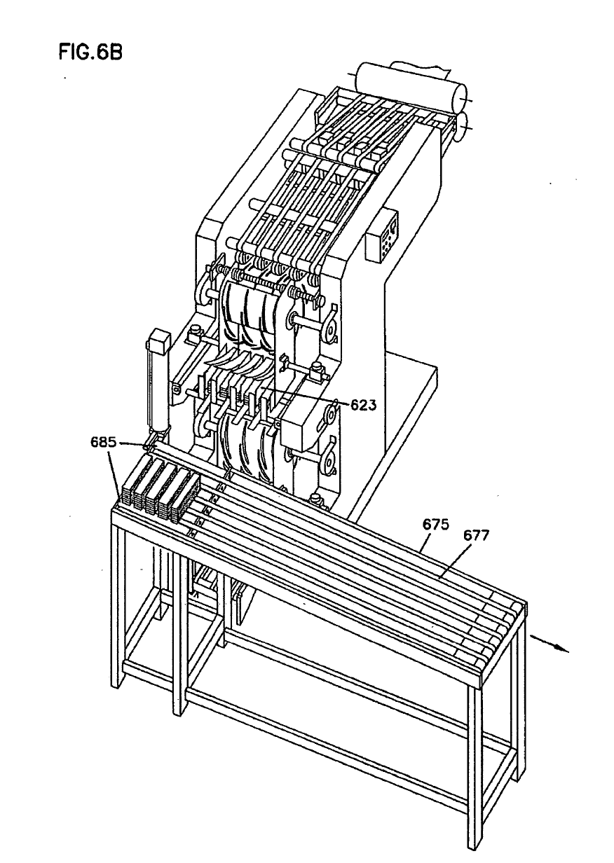

FIG. 6A depicts a perspective view of a portion of a collator module 16 in communication with a portion of a conveyor module 17 of an apparatus for preparing bundled printed sheets. Sheet stream transport 610, such as belts, rollers, vacuum transport belts, and like devices, or combinations thereof, transport and deliver the cut sheet streams to a batch stackers 620, preferably an optional second batch stacker 625, or optional additional batch stackers (not shown), to form, for example, a plurality of neatly stacked and registered sheets in adjacent stacks 630. Side walls 623, tab-stops 650, and like structures, can be included in the stacker to form a bin or chute for receiving the sheets and forming stacks. An optional elevator 660 can be employed when, for example, more than one batch stacker is stacking to shuttle completed batches of stacks 680 (e.g., 5 stacks across in each batch of stacks shown) from their respective stacker unit to a batch stack conveyor 670. The sheets received by the stacker can optionally be registered to achieve a unitary shape or uniform stack dimensions by, for example, jogging. Jogging can be accomplished by, for example, vibrating the side walls 623, tab-stops 650, and like structures, or combinations thereof, while the sheets are being collated into stacks in the stacker.

FIG. 6B depicts a related alternative to the conveyor module shown in FIG. 6A. In FIG. 6B the collator module (16 in FIG. 6A), again collating individual sheets into stacks within bins or chutes with sidewalls 623, is in communication with a reconfigured conveyor 675 situated next to the optional elevator 660 (hidden). This conveyor configuration is adapted to directly receive the stack batches from the elevator conveyor. Conveyor 675 is equipped with multiple rollers 685 (six shown) which facilitate a smooth transfer or “hand-off” of the batch stacks from the elevator conveyor in the multi-stack stream process direction to perpendicularly (in a horizontal plane) situated conveyor 675. It will be readily evident that conveyor 675 can be operated uni- or bi-directionally and as described for conveyor 690 in FIG. 7a below. Once the stacks reach a proper position on conveyor 675, a system controller, like controls, or an operator can cause a plurality of conveyor belts 677 to raise-up and above the level of the rollers 685 and cause the belts 677 to convey the stacks in a single stack stream to further down stream processing. Additional details of the conveyor configuration of FIG. 6B are shown in FIG. 7B and discussed below.

Collating the cut printed sheets can be accomplished, for example, with a collator having a receiver for receiving and registering each stream of printed sheets into an incipient registered stack. The receiver can be any suitable member for receiving the printed sheets, such as a bin, a tray, a pocket, a chute, and like members or structures. An example of a suitable receiver member or structure is associated with a commercially available Gannicott machine, for example, modified to simultaneously receive multiple cut printed sheets into separated bins or trays. Each bin or tray can have, in embodiments, two side-walls, a front wall, and an optional back wall. The tray or bindexer can have, in embodiments, sidewall fingers which permit mechanical “jogging” of the printed sheets as they are received from the die-cutter or other cutting device by the collator's respective stacker bins. Collating of a number of streams of printed sheets preferably produces a correspondingly equal number of registered stacks. Registered stacks or their resulting bundle of printed sheets can have, for example, from about ten to about 10,000 printed sheets, preferably from about ten to about 5,000 printed sheets, and more preferably from about ten to about 1,500 printed sheets, where the preference here reflects, in various embodiments, a balance between minimized packaging (larger stacks and economies of scale) and adequate stack or bundle size for convenient manual handling (smaller stacks and human factors) in a particular industrial application, such as label applicators. Other bundled printed sheet sheet-counts may preferred in other applications.

The registered stacks can be, for example: vertical and unsupported, (i.e. sheets laying flat with one face oriented downward and the other face oriented upward, wherein the sheets are stacked upward atop one another); vertical and supported; or horizontal and supported. Preferably, each registered stack is formed in a vertical orientation, that is, having sheets stacked or layered on top of one another and which verticality can avoid the need for additional structural supports, that is, the stacks are preferably unsupported. Stack “support” in this regard refers to, for example, any suitable support structure or a mechanism suitable for maintaining the stack in a localized position while it is being formed, and to maintain the stack's desired properties, such as shape, handling, and appearance, during and after the time the stack is formed. A support structure or a mechanism can be, for example, a portion of the collator, such as a wall or stop. “Jogging” the stack with respect to a mechanical collator and collating the printed sheets refers to mild agitation or a shuffling disturbance which causes the cut sheets to align into more uniform or unitary stacks. “Jogging” of the stack with respect to an operator refers to mild manual agitation or shuffling disturbance, such as tapping the stack or bundle with a wood block, which also causes the cut sheets to align into more uniform or unitary stacks or bundles. The stacks can be supported for a time, for example, while being formed, that is, during the stacking of sheets, and unsupported for a time, for example, while being transported on a conveyor.

The registered stacks can be, for example, edge-to-edge registered, side-to-side registered, height-registered, edge-registered, width-registered, weight registered, or combinations thereof. The stack height is predetermined, for example, by customer preferences, limits on the change range in the collator tooling, optimizing space utilization in, for example, containerizing or like packaging or storing considerations. Achieving the predetermined stack height can be accomplished by, for example, a sheet counter, or similar mechanism associated with the collator. A Gannicott die-cutting machine having a stack height counter is commercially available. Preferably, each registered stack is at least height registered and edge-to-edge registered. More preferably, each registered stack is at least edge-to-edge registered.

FIG. 7A depicts a perspective view of a portion of a conveyor module 17 of an apparatus for preparing bundled printed sheets of FIG. 6A including the above mentioned first batch stack conveyor 670 for conveying completed batches of stacks 680 to a second batch stack conveyor 690. As shown, a stack stream comprised of successively produced batches of stacks 680, for example, having five stacks each, is conveyed on conveyor 670 and transferred to conveyor 690 to form a merged single stack stream 710. Optionally, conveyor 690 can be adapted to operate bi-directionally or reciprocate to permit the merged stack stream to provide a second stack stream 720 when the conveyor 690 is operated in the reverse direction 720. The merged stack streams 710 or 720 convey the stacks in “single-file” fashion on conveyor 690 to subsequent packaging stations. Conveyors 670 and 690 can be a single belt, a plurality of belts, rollers, and like conveyor devices, or combinations thereof.

FIG. 7B depicts a portion of the conveyor module shown in FIG. 6B and discussed above. A first conveyor 660, for example in embodiments, the elevator conveyor of FIG. 6B transfers batch stacks to a second conveyor 760. Optional support 750 having an optional roller can be included to further facilitated the transfer and avoid or minimize, for example, stack tipping or disruption of sheets within the uniform stacks. Second conveyor 760 can include plural rollers 765 for receiving and positioning the batch stacks on conveyor 760. In one example, plural belts 770 on conveyor 760 were situated perpendicular to plural belts of first conveyor 660. Stack batches advanced on conveyor 660 were transferred to conveyor 760 on rollers 765 and thereafter plural belts 770 were engaged to convey a single stack stream to further processing 780 In one embodiment, a first conveyor conveys one or more stacks, such as from about one to about eight stacks, more preferably two to about forty stacks, and even more preferably about five to about twenty stacks, at the same time from the stacker to a second conveyor. Here the preference reflects a desire to optimize or match sheet handling and stack handling hardware and capacity with total throughput economics. The second conveyor's path or process direction can be situated perpendicular to the first conveyor. In embodiments, to provide greater stack handling and stack through-put, the first conveyor can include an elevator which permits switching stack staging and conveyance between an upper first conveyor and a lower first conveyor. For example, while the upper first conveyor conveys stacks to the second conveyor the lower first conveyor is held stationary to receive stacks. When the upper first conveyor has completed conveyance of its stacks to the second conveyor and the lower first conveyor has received its stacks the elevator changes the positions and the roles of the upper and lower first conveyors to stack staging and stack conveyor, respectively. Thus, in embodiments, the collator forms one or more stacks by continuously collating printed sheets. The completed stacks are placed onto one or more conveyors and conveyed to a second conveyor situated, for example, perpendicular to the first conveyor. The perpendicular orientation of the second conveyor relative to the first conveyor causes the stacks conveyed by the second conveyor to be conveyed in the same direction and in a single stream, “single-file.” The second conveyor can convey alternating stack batches or loads received from the first conveyor in different directions, such as the opposite (180 degrees) direction, perpendicular (ninety degrees) direction, and like acute or obtuse intermediate angle directions, to provide two stack streams (“split-stream”) where each stack stream is separately packaged in one or more packaging operations. In various embodiments in which, for example, the collator module has two batch stackers operating in and situated in an over-under relation, the conveyor module can include, for example, a conveying elevator, the elevator being operable to alternately receive a batch of stacks from each batch stackers, and to convey the received batch of stacks to a first conveyor for further processing. The first conveyor can convey the received batch of stacks as a stack stream uni-directionally to the packaging module. The first conveyor can also be configured to split the merges single stack stream into two or more stack streams, and to convey the received batch of stacks as a stack stream bi-directionally to two or more packaging modules.

In embodiments in which, for example, the collator module has two batch stackers operating in an over-under relation, the conveyor module can include, for example, two conveyors, with each batch stackers having one of the two conveyors dedicated to receiving its batched stacks, and each conveyor being adapted to convey the batched stacks to further packaging as batches of stacks (e.g., five stacks abreast) or as a single stack stream (i.e., one stack abreast or single-file). Thus, in various embodiments of the disclosure, there are a number of conveyor configurations, which can accomplish efficient conveyance of batch stacks or stack streams and without an elevator shuttling between batch stackers or otherwise.

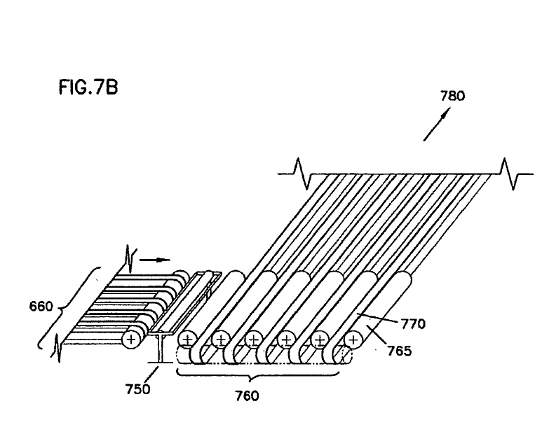

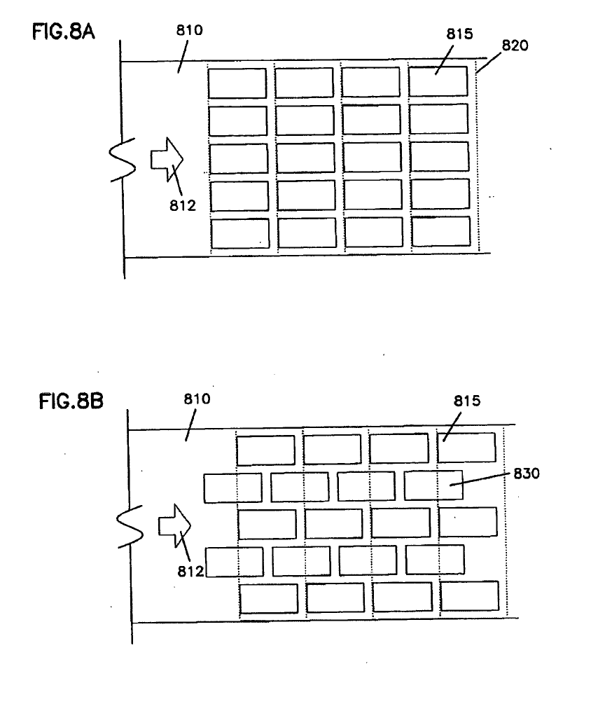

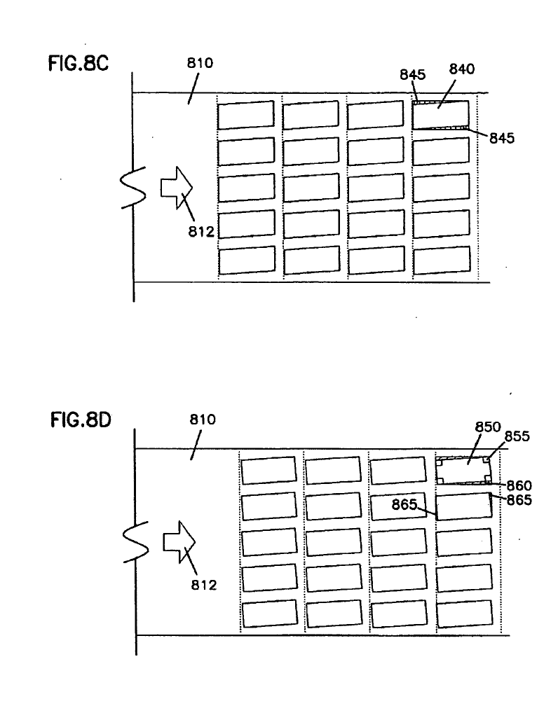

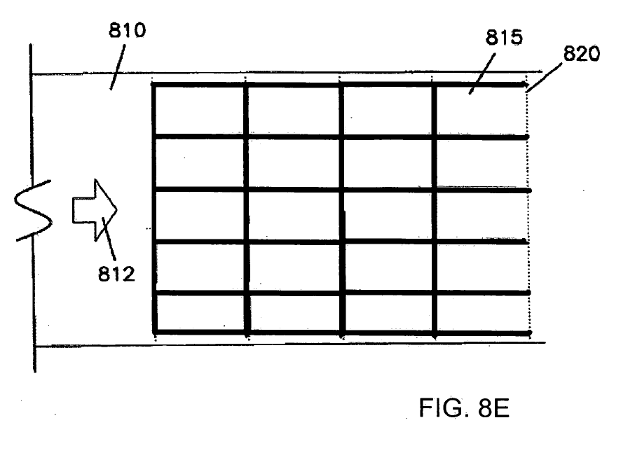

FIG. 8A-8E depict, in various embodiments, examples of various cut patterns for forming cut printed sheets. FIG. 8A depicts an example of an aligned-cut pattern, where a web 810 traveling in process direction 812 is cut with a cutter module, such as a die-cutter, to produce a cut sheet 815 which sheet is separated from the web to form a sheet stream and its corresponding cut-out void which is part of the waste matrix. Imaginary reference lines 820 show the relative “aligned” orientation of the cut sheet 815 to the normal (perpendicular in-plane) direction across or traversing the web process direction.

FIG. 8B depicts an example of a staggered-cut pattern, where a web 810 traveling in process direction 812 is cut with a cutter module, such as a die-cutter, to produce a cut sheet 815 which sheet is separated from the web to form a sheet stream and its corresponding cut-out void which is part of the waste matrix. Reference lines 820 show the relative “stagger” orientation of cut sheet 815 to adjacent stagger cut sheets 830 to the normal direction across the web process direction.

FIG. 8C depicts an example of a skewed angle-cut pattern, where a web 810 traveling in process direction 812 is cut with a cutter module, such as a die-cutter, to produce a skewed-cut sheet 840 having a very slight parallelogram shape which sheet is separated from the web to form a sheet stream and its corresponding cut-out void which is part of the waste matrix. Reference regions 845 show the relative “skew” or angle-cut orientation of the cut lines in the process direction of cut sheet 840.

FIG. 8D illustrates an example of a square angle-cut pattern, where a web 810 traveling in process direction 812 is cut with a cutter module, such as a die-cutter, to produce a square-cut sheet 850, that is having all square corners 855, and which sheet is separated from the web to form a sheet stream and its corresponding cut-out void which is part of the waste matrix.

Reference regions 860 and 865 show the slight shift or skew angles of the cut lines in the process direction and the across the process direction, respectively.

FIG. 8E depicts an example of an aligned-cut pattern, where a web 810 traveling in process direction 812 is cut with a cutter module, such as a laser die-cutter, to produce a cut sheet 815 which sheet is separated from the web to form a sheet stream and its corresponding cut-out void. The waste matrix can be virtually eliminated with laser die-cutting because cut sheets 815 are butted up next to each other. If desired, the edges of the web may be slit off and collected as waste. Imaginary reference lines 820 show the relative “aligned” orientation of the cut sheet 815 to the normal (perpendicular in-plane) direction across or traversing the web process direction. In other embodiments, laser die-cutting can also be used to cut and slit with a matrix, similar to the pattern illustrated in FIGS. 8A-8D. A matrix may be desired if an uncommon bleed is present, for example.

It is understood that the abovementioned cut patterns and methods for web cutting can be readily adapted and are applicable to sheet-fed cutting embodiments. It is also understood that the abovementioned cut patterns are illustrative and are not intended to restrict the possible shapes or dimensions of the cut sheets, stacks, or bundles of the disclosure.

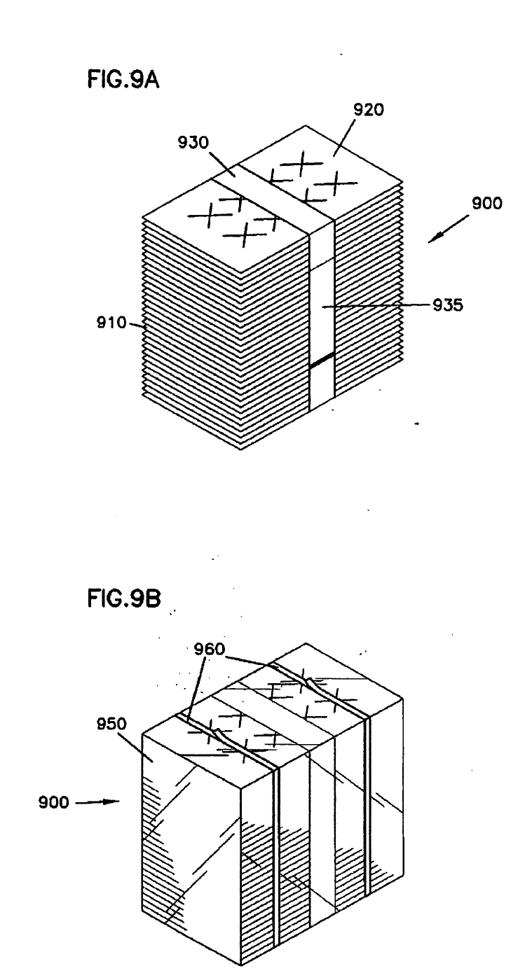

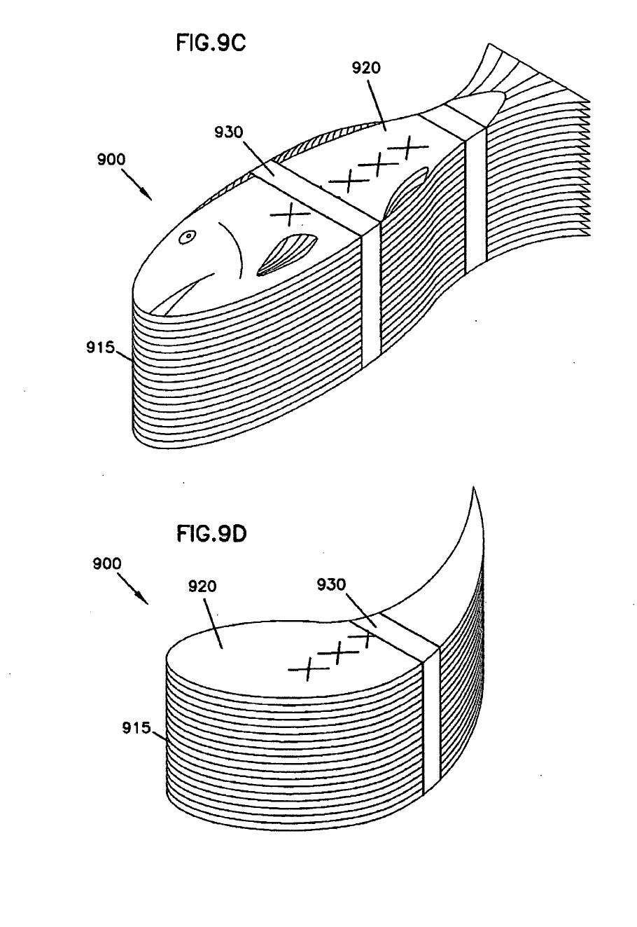

FIG. 9A depicts an exemplary bundle of printed sheets 900 of the present disclosure, having a plurality of registered, neatly stacked, cut sheets 910, having printing (e.g., images, patterns, line art, and like marks), printed indicia (e.g., text, figures, and like marks), or both 920, on one or both sides, such as label or product information, a band 930 encompassing the stack of printed sheets of the bundle, and a band overlap region 935 which can provide a point of attachment or fastening of the band to itself.

FIG. 9B depicts the banded bundle of printed sheets 900 of FIG. 9A further including a clear or translucent protective overwrapper 950, and one or more optional tear-tapes or pull-tabs 960 to facilitate unwrapping of the overwrapped bundle. The overwrapper 950 can be shrunk by, for example, known shrink-wrapping methods, such as the application of heat or radiation, to form a tightly sealed bundle.

FIGS. 9C and 9D depict other examples of bundle of printed sheets 900 of the present disclosure having alternative stack or bundle geometries while still having a plurality of registered, neatly stacked, cut sheets 915, images, printed indicia, or both 920, on one or both sides, such as label or product information, a band 930 encompassing the stack of printed sheets to form a bundle, and an optional band overlap region 935 which can provide a point of attachment or fastening of the band to itself. FIGS. 9C and 9D additionally illustrate that, in embodiments, the sheets and their resulting stack and bundles of printed sheets can have a unitary shape other than a cube or a parallelepiped, including for example irregular aspects, curved aspects, notched aspects, peaked aspects, and like aspects, or combinations thereof, which aspects taken together can be functional, aesthetic, or both. The bundle of printed sheets of FIG. 9C can be, for example, a food product label or a promotional item. FIG. 9D can be for example a sports product label or insignia label.

Other advantages of the inline apparatus and production process for making bundled printed sheets of the present disclosure can include, for example, particularly when a precision rotary die-cutter is used: chipboard or like rigid stack supports are not required to maintain stack integrity during or after manufacture; the apparatus and production are less costly to operate compared to alternative systems; and the apparatus and production process, in embodiments, provide improved product-to-product consistency, such as sheet-to-sheet and bundle-to-bundle size uniformity, lot-to-lot uniformity, that is where there is time gap between identical print jobs, print registration, and print registration to cut edges of the sheets and their bundles. By comparison current state of the art guillotine cutting systems provide cut sheet variance of greater than about plus/minus 3/64 inches. The improved print registration to cut edges reduces paper waste, ink waste, reject waste, and improves the appearance and customer acceptance of the bundled printed sheets and the individual printed sheets, such as in consumer product label applications. Furthermore, the apparatus and process of the disclosure can reduce the total time to manufacture a supply of printed sheets, such as labels, from twelve to twenty-four hours to, for example, about one to about four minutes. Standing or storing of cut printed sheets or bundles of printed sheets, for drying, curing, or like processes, is not necessary in embodiments of the disclosure. The bundles of printed sheets and the cut printed sheets therein, in embodiments of the disclosure, can be ready, if desired, for immediate customer use, for example, in the application of labels to articles. In embodiments the high cut-to-print registration can provide printing processes and products with design or artwork freedom advantages, for example, having artwork capabilities with uncommon bleeds, and avoiding the requirement for solid “banded” borders which are typically required, for example, in conventionally prepared guillotine cut-labels.

TABLE 1 provides an exemplary operation-time summary of a web-based production system for the manufacture, start-to-finish, of a single bundle of printed sheets product of the invention, as described herein above.

TABLE 1
Approximate operation-time summary for web-based manufacture
of a single bundle of printed sheets

| OPERATION/MODULE | TIME |
|---|---|
| web printing (8 color offset with | about 1 to about 30 seconds |
| concurrent intermediate UV cure; | |
| web speed average = 300 feet | |
| per min) | |
| web coating (varnish - single side) | less than about 1 second |
| web crying (air) | less than about 5 seconds |
| web chilling (chilled rollers) | about 1 to about 5 seconds |
| cutting (die-cutter) | less than about 1 second |
| sheet transfer (sheet stream) | about 1 to about 2 seconds |
| collating (for stacks of 1,000 sheets | about 30 seconds to about 120 |
| each with 2 batch stackers) | seconds |
| conveying (one stack to banding; 1^{st} | about 5 to about 30 seconds |
| and 2^{nd} conveyors) | |
| packaging (banding - 2 bands applied | (about 5 to about 10 seconds) |
| simultaneously) | |
| (complete plastic overwrap) | (about 90 to about 120 seconds) |
| (containerizing - corrugated box wrap) | (less than about 5 seconds) |
| (box sealing - tape) | (about 1 to about 10 seconds) |
| (carrier loading - each box stacked by | (about 5 to about 15 seconds) |
| an operator) | |
| TOTAL | about 140 to about 350 seconds |
| | (about 2.5 to about 6 minutes) |

In some embodiments of the disclosure, in the manufacture of bundled printed sheets there can be incidental or intentional holdup, that is a slight delay or a slow-step in one or more manufacturing steps, for example, to accommodate limitations on equipment or operators, such as in manual packaging operations, shift changes, and like circumstances. Holdup can be minimized or eliminated, as desired, with different configurations, equipment, belt speeds, and like modifications, or combinations thereof.

In system 10 of the present invention, cutting module 14 is often the rate limiting step. Printing presses can be run at maximum speeds of about 1000 feet per minute in one embodiment, while cutting modules may run at a maximum speed of only about 300 to about 400 feet per minute. Printing presses also tend to be more costly than subsequent converting lines. Therefore, it may be desirable to print and convert the web or sheets in separate stages to accommodate the varying equipment speeds while reducing capital costs, running two, three, or more converting lines for each printing press. In a two-stage web process according to one embodiment of the present invention, for example, the web is unwound before printing module 12, marked with a registration mark, and rewound after printing module 12. The roll is then transferred to a converting line containing at least one cutter module 14. The roll is re-registered upon unwinding, die cut by cutter module 14, such as a rotary die-cutter, laser die-cutter, and the like or combinations thereof. The individual cut sheets are then collated, stacked, and/or packaged, as described above. This multiple stage process can therefore improve overall production speeds while reducing capital equipment costs.

All publications, patents, and patent documents are incorporated by reference herein in their entirety, as though individually incorporated by reference. The disclosure has been described with reference to various specific and preferred embodiments and techniques. However, it should be understood that many variations and modifications can be made while remaining within the spirit and scope of the disclosure.

What is claimed is:

1. An apparatus for making bundled printed sheets, comprising:
a printable web;
a print module to print on the printable web;
a cutter module to cut the printed web into a stream of printed sheets;
a collator module to collate each stream of printed sheets into a registered stack;
a conveyor module to convey each registered stack into a stack stream; and
a packaging module to package each registered stack in the stack stream into a package comprised of a bundle of printed sheets.
